(19) United States
(12) Patent Application Publication
(10) Pub. No.: US 2018/0292980 A1
(43) Pub. Date: Oct. 11, 2018

(54) SYSTEM, INFORMATION PROCESSING METHOD, AND STORAGE MEDIUM

(71) Applicant: CANON KABUSHIKI KAISHA, Tokyo (JP)

(72) Inventors: Hideo Noro, Tokyo (JP); Masakazu Matsugu, Yokohama-shi (JP)

(21) Appl. No.: 15/940,530

(22) Filed: Mar. 29, 2018

(30) Foreign Application Priority Data
Apr. 10, 2017 (JP) 2017-077659

(51) Int. Cl. G06F 3/0484; G06F 3/01; G06K 9/00; G06T 1/00; G02B 27/01

(52) U.S. Cl. CPC G06F 3/04842; G06F 3/013; G06K 9/00221; G02B 2027/0178; G02B 27/017; G06T 2207/30201; G06T 2207/30204; G06T 1/0007

(57) ABSTRACT

A system generates presentation information to a user based on a visual recognition target of the user, displays the generated presentation information on a first display unit of a first information processing device, determines detailed information related to the presentation information based on the presentation information displayed on the first display unit, and displays the determined detailed information on a second display unit of a second information processing device which is different from the first information processing device. Further, the system selects the presentation information in response to a designation from the user from among a plurality of the presentation information pieces displayed on the first display unit, and detects whether the selected presentation information is a selection mistake.

### BACKGROUND OF THE INVENTION

### Field of the Invention

The present invention relates to a system, an information processing method, and a storage medium.

### Description of the Related Art

There are methods for detecting and presenting specific targets from still images and moving images captured by image capturing devices such as cameras.

For example, in the field of monitoring cameras, when a person who acts suspiciously is detected, abnormality is notified, and the suspicious person is indicated in a colored frame, and the like.

In addition, there are systems which recognize and present persons' faces. For example, casinos use systems for recognizing persons on blacklists in order to prevent fraudulent card counting and the like.

In the field of automobiles, systems are developed which identify travelable ranges, pedestrians, vehicles, and the like from videos of on-vehicle cameras, sense dangers in advance, and take actions such as notifying drivers of the dangers and avoiding the dangers.

As described above, there are various systems which identify certain targets from still images and moving images captured by image capturing devices and present information pieces regarding the identified targets.

Information to be presented includes simple information such as a name of the identified target and detailed information of the identified target.

Methods for presenting information include annotation and notification.

Annotation is a method used in an augmented reality (AR). The method is for displaying summary information such as a name related to an object in an image by superimposing on the vicinity of the object.

Notification is a method used for notifying a user of some events. For example, ringing tones and caller number display of telephones and notices of electronic mails and social networking service (SNS) of smartphones are examples of notification.

Annotation and notification are useful to present information to users, however, the users want to know further detail information in some cases.

A method for selecting information presented as annotation and displaying detailed information related to the selected information is described in Japanese Patent Application Laid-Open No. 2012-69065.

A method for displaying notification on a monitoring screen when an abnormality occurs in an individual device and displaying the individual abnormality on a screen of an apparatus different from the monitoring screen in a plant monitoring system is described in Japanese Patent Application Laid-Open No. 05-342487.

However, according to the method described in Japanese Patent Application Laid-Open No. 2012-69065, the detailed information is displayed on a same screen (display device) on which information such as annotation is presented.

Thus, the screen is difficult to see because many information pieces are displayed on the screen, and user convenience is low in terms of difficulty in browsing of detailed information and in a related operation. Particularly, in a case of a head-mounted display (HMD), a line-of-sight direction of a user is restricted depending on a display position of the detailed information, and it is less convenient.

According to the method described in Japanese Patent Application Laid-Open No. 05-342487, only information related to an abnormality of a predetermined monitoring target can be presented, and information corresponding to a target visually recognized by a user cannot be presented, so that it is less convenient.

### SUMMARY OF THE INVENTION

A system according to the present invention includes a generation unit configured to generate presentation information to a user based on a visual recognition target of the user, a first display control unit configured to display the presentation information generated by the generation unit on a first display unit of a first information processing device, a determination unit configured to determine detailed information related to the presentation information based on the presentation information displayed on the first display unit by the first display control unit, a second display control unit configured to display the detailed information determined by the determination unit on a second display unit of a second information processing device which is different from the first information processing device, a selection unit configured to select the presentation information corresponding to a designation from the user as selection information from among a plurality of the presentation information pieces displayed on the first display unit by the first display control unit, and a first detection unit configured to perform detection processing for detecting that selection of the selection information by the selection unit is a selection mistake by the selection unit.

Further features of the present invention will become apparent from the following description of exemplary embodiments with reference to the attached drawings.

### BRIEF DESCRIPTION OF THE DRAWINGS

FIG. 1 illustrates an example of a system configuration of an information processing system.

FIGS. 2A and 2B illustrate examples of a hardware configuration of each component in the information processing system.

FIG. 3 illustrates an example of a functional configuration of each component in the information processing system.

FIGS. 4A and 4B illustrate outlines of examples of processing by the information processing system.

FIGS. 5A and 5B illustrate outlines of examples of presentation of information.

FIG. 6 illustrates an example of a functional configuration of each component in the information processing system.

FIG. 7 is an activity diagram illustrating an example of processing by a display information control unit.

FIG. 8 illustrates an example of a functional configuration of each component in the information processing system.

FIG. 9 illustrates an example of processing for detecting an orientation of a summary information display device.

FIG. 10 is an activity diagram illustrating an example of processing by a detailed information gazing detection unit.

FIG. 11 illustrates an example of a functional configuration of each component in the information processing system.

FIG. 12 illustrates an example of processing for detecting an orientation of a detailed information display device.

FIG. 13 illustrates an example of a functional configuration of each component in the information processing system.

FIG. 14 illustrates an example of a display aspect of detailed information.

FIG. 15 is an activity diagram illustrating an example of processing by a detailed information gazing detection unit.

FIG. 16 illustrates an example of a functional configuration of each component in the information processing system.

FIG. 17 illustrates an example of a usage aspect of the information processing system.

FIG. 18 illustrates an example of a captured image.

FIG. 19 is an activity diagram illustrating an example of processing by the detailed information gazing detection unit.

FIG. 20 illustrates an example of a captured image.

FIG. 21 illustrates an example of a functional configuration of each component in the information processing system.

FIG. 22 is an activity diagram illustrating an example of processing by the detailed information gazing detection unit.

FIG. 23 illustrates an example of a functional configuration of each component in the information processing system.

FIGS. 24A and 24B are activity diagrams illustrating an example of being-operating estimation processing.

FIG. 25 is an activity diagram illustrating an example of processing by the detailed information gazing detection unit.

FIG. 26 illustrates an example of a functional configuration of each component in the information processing system.

FIGS. 27A and 27B are activity diagrams illustrating an example of processing by a summary information filter unit.

FIGS. 28A and 28B are activity diagrams illustrating an example of processing by a selection mistake detection unit.

FIG. 29 illustrates an example of a functional configuration of each component in the information processing system.

FIG. 30 is a state machine diagram illustrating an example of processing by the selection mistake detection unit.

FIG. 31 is an activity diagram illustrating an example of processing by a summary information selection unit.

FIG. 32 is an activity diagram illustrating an example of processing by a summary information selection unit.

FIG. 33 illustrates an example of a functional configuration of each component in the information processing system.

FIG. 34 is an activity diagram illustrating an example of processing by the summary information selection unit.

FIG. 35 illustrates an example of a functional configuration of each component in the information processing system.

FIG. 36 illustrates an example of a functional configuration of each component in the information processing system.

FIG. 37 is an activity diagram illustrating an example of processing by the summary information selection unit.

FIG. 38 is an activity diagram illustrating an example of processing by the selection mistake detection unit.

FIG. 39 is an activity diagram illustrating an example of processing by the summary information selection unit.

FIGS. 40A and 40B illustrate outlines of processing by the selection mistake detection unit.

### DESCRIPTION OF THE EMBODIMENTS

Various exemplary embodiments of the present invention will be described in detail below with reference to the attached drawings.

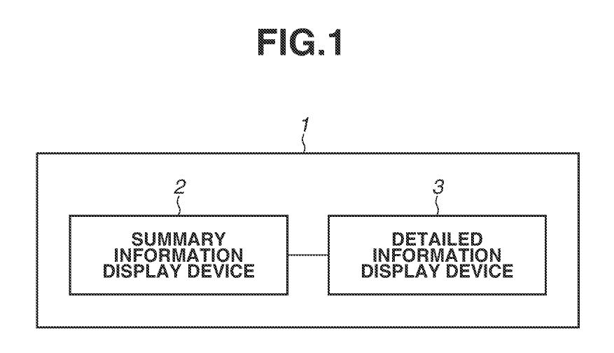

FIG. 1 illustrates an example of a system configuration of an information processing system 1 according to a first exemplary embodiment.

The information processing system 1 includes a summary information display device 2 and a detailed information display device 3. The summary information display device 2 and the detailed information display device 3 are communicatably connected to each other. According to the present exemplary embodiment, the summary information display device 2 and the detailed information display device 3 are wirelessly and communicatably connected to each other, however, may be connected in a wired manner.

The summary information display device 2 presents information related to an image and an actual landscape visually recognized by a user to the user. The summary information display device 2 is constituted of an eyeglass type terminal device such as a smart glass, a head-mounted type terminal device such as an HMD, and a terminal device such as a smartphone and a tablet device. The summary information display device 2 may be constituted of a personal computer (PC), a server, and the lime. According to the present exemplary embodiment, the summary information display device 2 presents information indicating summaries of an object (e.g., a building) and an event (e.g., weather), such as names thereof, in an image and an actual landscape visually recognized by a user to the user. Information indicating summaries such as names of the object and the event is referred to as summary information. In other words, the summary information display device 2 presents the summary information to a user. The present invention is not intended to limit the summary information to the above-described ones and may be adopted to a case in which a person is detected from an image captured by a monitoring camera, and a detection frame, a person name, a personal identification (ID), and the like are presented as the summary information indicating the detected result.

The detailed information display device 3 presents detailed information regarding the summary information presented by the summary information display device 2 to a user. Information indicating details of an object and an event is referred to as detailed information. In other words, the detailed information display device 3 presents the detailed information to a user. The detailed information display device 3 is constituted of a terminal device such as a smartphone and a tablet device. The detailed information display device 3 may be constituted of a PC, a server, and the like. In addition, the detailed information display device 3 may include, for example, an on-vehicle display in a car entertainment system and a multifunctional television.

According to the present exemplary embodiment, the information processing system 1 presents the detailed information regarding the summary information presented to a user via the summary information display device 2 to the user via the detailed information display device 3. The summary information display device 2 and the detailed information display device 3 are examples of information processing devices.

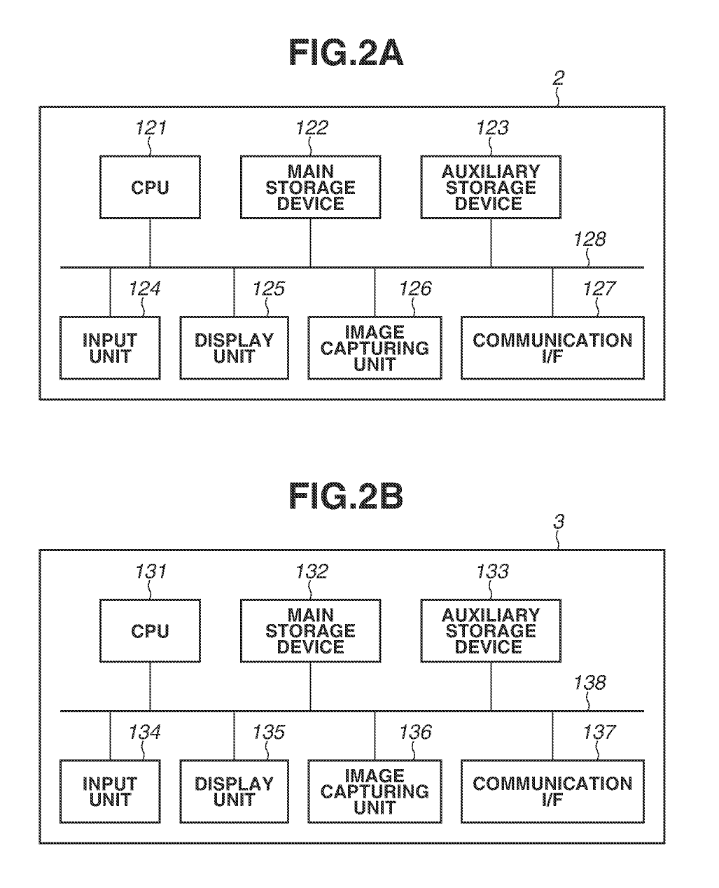

FIGS. 2A and 2B illustrate examples of a hardware configuration of each component in the information processing system 1. FIG. 2A illustrates an example of a hardware configuration of the summary information display device 2. The summary information display device 2 includes a central processing unit (CPU) 121, a main storage device 122, an auxiliary storage device 123, an input unit 124, a display unit 125, an image capturing unit 126, and a communication interface (I/F) 127. Each component is connected to each other via a system bus 128.

The CPU 121 controls the summary information display device 2. The main storage device 122 includes a random access memory (RAM) and the like which functions as a work area of the CPU 121 and a temporary storage area for information. The auxiliary storage device 123 includes a read-only memory (ROM), a hard disk drive (HDD), a solid state drive (SDD), and the like which stores various programs, various setting information pieces, various images, candidate information pieces of various presenting information pieces, and the like.

The input unit 124 is an input device such as a hard button, a dial device, a touch panel, a keyboard, a mouse, and a touch pen which receives an input from a user. The display unit 125 is a display device such as a display and a transmission type display for displaying information. The image capturing unit 126 is an image capturing device such as a camera. The communication I/F 127 is used for communication with an external device such as the detailed information display device 3.

The image capturing unit 126 may be a camera installed in a remote location and a recording device for distributing a recorded video. In this case, the image capturing unit 126 is connected to each component in the summary information display device 2 via the communication I/F 127.

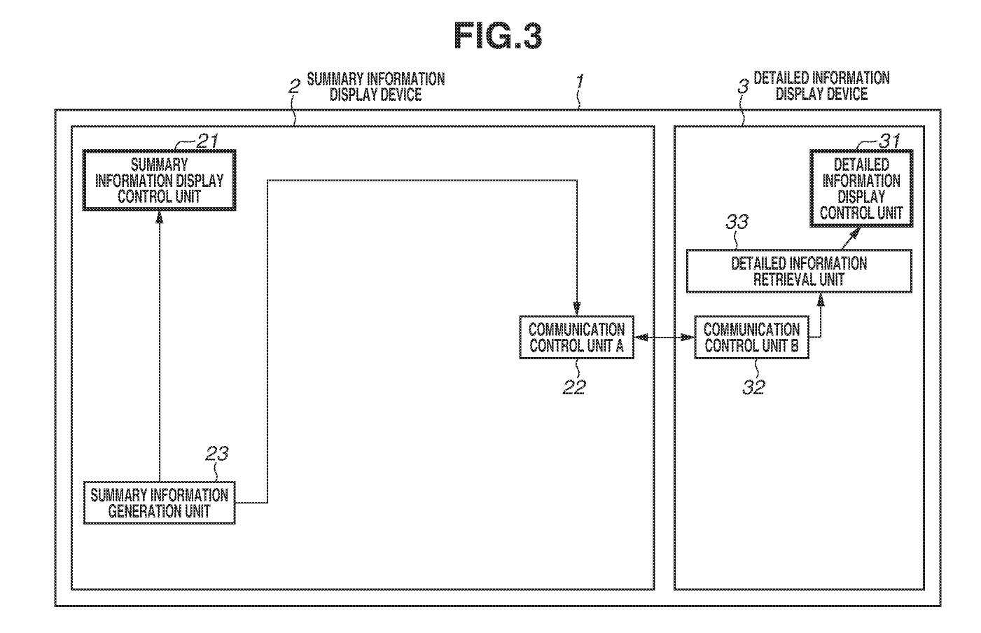

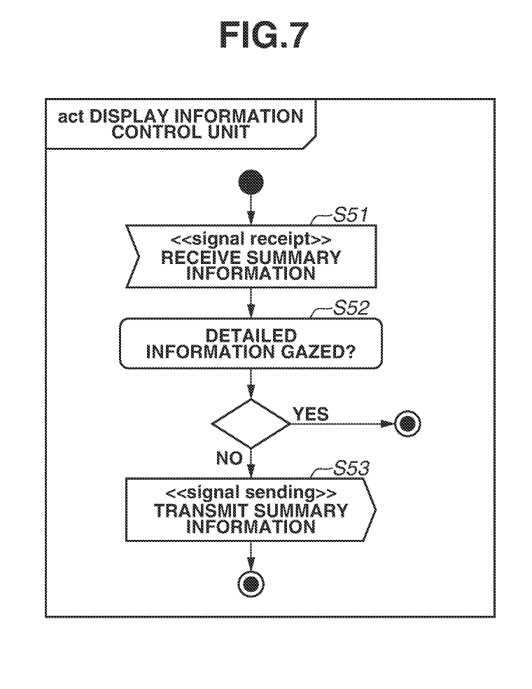

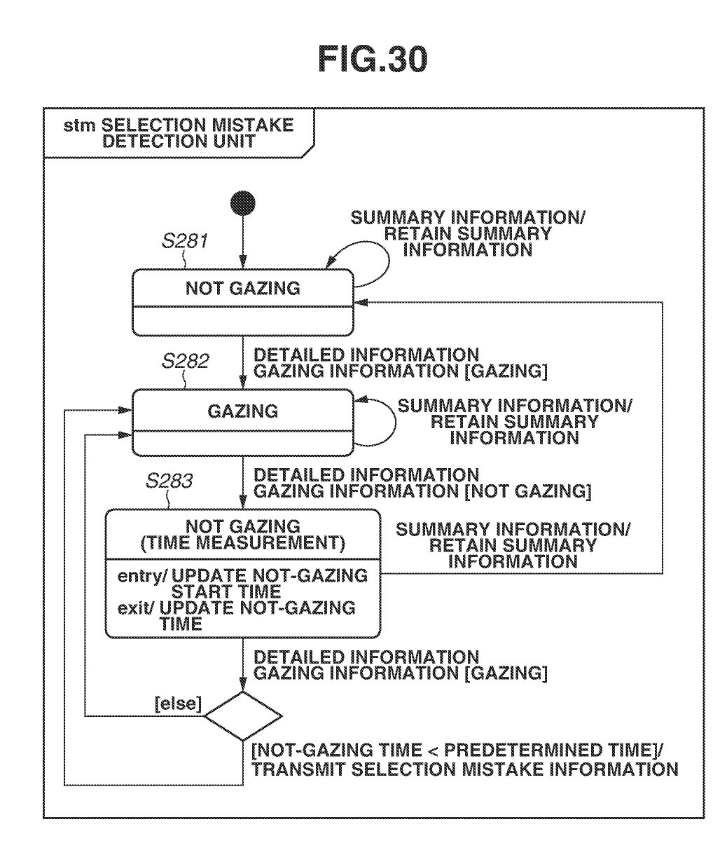

The CPU 121 executes processing based on a program stored in the auxiliary storage device 123, and accordingly, functions of the summary information display device 2 can be realized which are described below with reference to FIGS. 3, 6, 8, 11, 13, 16, 21, 23, 26, 29, 33, 35, and 36. Further, the CPU 121 executes processing based on a program stored in the auxiliary storage device 123, and accordingly, processing of the summary information display device 2 such as the ones illustrated in activity diagrams described below in FIGS. 7, 10, 15, 25, 27, 28, 31, 32, 34, 37, 38, and 39 can be realized. Furthermore, the CPU 121 executes processing based on a program stored in the auxiliary storage device 123, and accordingly, processing illustrated in a state machine diagram described below in FIG. 30 can be realized.

FIG. 2B illustrates examples of a hardware configuration of the detailed information display device 3. The detailed information display device 3 includes a CPU 131, a main storage device 132, an auxiliary storage device 133, an input unit 134, a display unit 135, an image capturing unit 136, a communication I/F 137. Each component is connected to each other via a system bus 138.

The CPU 131 controls the detailed information display device 3. The main storage device 132 includes a RAM and the like which functions as a work area of the CPU 131 and a temporary storage area for information. The auxiliary storage device 133 includes a ROM, an HDD, an SDD, and the like which stores various programs, various setting information pieces, various images, candidate information pieces of various presenting information pieces, and the like.

The input unit 134 is an input device such as a hard button, a dial device, a touch panel, a keyboard, a mouse, and a touch pen which receives an input from a user. The display unit 135 is a display device having the touch panel and a display device such as a display for displaying information. The image capturing unit 136 is an image capturing device such as a camera. The communication I/F 137 is used for communication with a communication destination such as the summary information display device 2, a database device which is not illustrated, and an external device on the Internet.

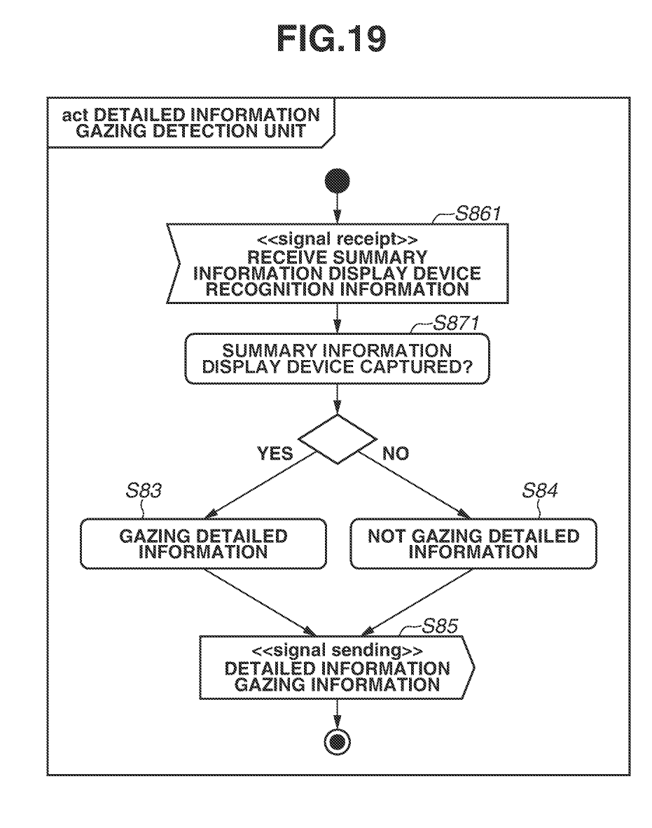

The CPU 131 executes processing based on a program stored in the auxiliary storage device 133, and accordingly, functions of the detailed information display device 3 can be realized which are described below with reference to FIGS. 3, 6, 8, 11, 13, 16, 21, 23, 26, 29, 33, 35, and 36. Further, the CPU 131 executes processing based on a program stored in the auxiliary storage device 133, and accordingly, processing of the detailed information display device 3 such as the ones illustrated in activity diagrams described below in FIGS. 19, 22, and 24 can be realized.

FIG. 3 illustrates an example of a functional configuration of each component in the information processing system 1.

The summary information display device 2 includes a summary information display control unit 21, a communication control unit A 22, and a summary information generation unit 23. The summary information display control unit 21 is an example of a first display control unit.

The summary information display control unit 21 displays summary information generated by the summary information generation unit 23 on the display unit 125. The communication control unit A 22 performs communication with the external device such as the detailed information display device 3 as the communication destination. The summary information generation unit 23 generates the summary information to be presented to a user based on a visual recognition target of the user such as an image displayed on the display unit 125 and an actual landscape. According to the present exemplary embodiment, the image displayed on the display unit 125 and the actual landscape visually recognized by a user is captured via the image capturing unit 126. Thus, the summary information generation unit 23 according to the present exemplary embodiment generates the summary information to be presented to a user based on an image captured via the image capturing unit 126.

The detailed information display device 3 includes a detailed information display control unit 31, a communication control unit B 32, and a detailed information retrieval unit 33. The detailed information display control unit 31 is an example of a second display control unit.

The detailed information display control unit 31 displays detailed information retrieved by the detailed information retrieval unit 33 on the display unit 135. The communication control unit B 32 communicates with the external device such as the summary information display device 2. The detailed information retrieval unit 33 retrieves the detailed information to be presented to a user based on the summary information displayed on the display unit 125 by the summary information display control unit 21.

The summary information display device 2 and the detailed information display device 3 communicates with each other by the communication control unit A 22 and the communication control unit B 32 via the communication I/F 127 and the communication I/F 137.

It is described above that the summary information generation unit 23 is included in the summary information display device 2, however, the summary information generation unit 23 may be included in the detailed information display device 3. Further, it is described above that the detailed information retrieval unit 33 is included in the detailed information display device 3, however, the detailed information retrieval unit may be included in the summary information display device 2.

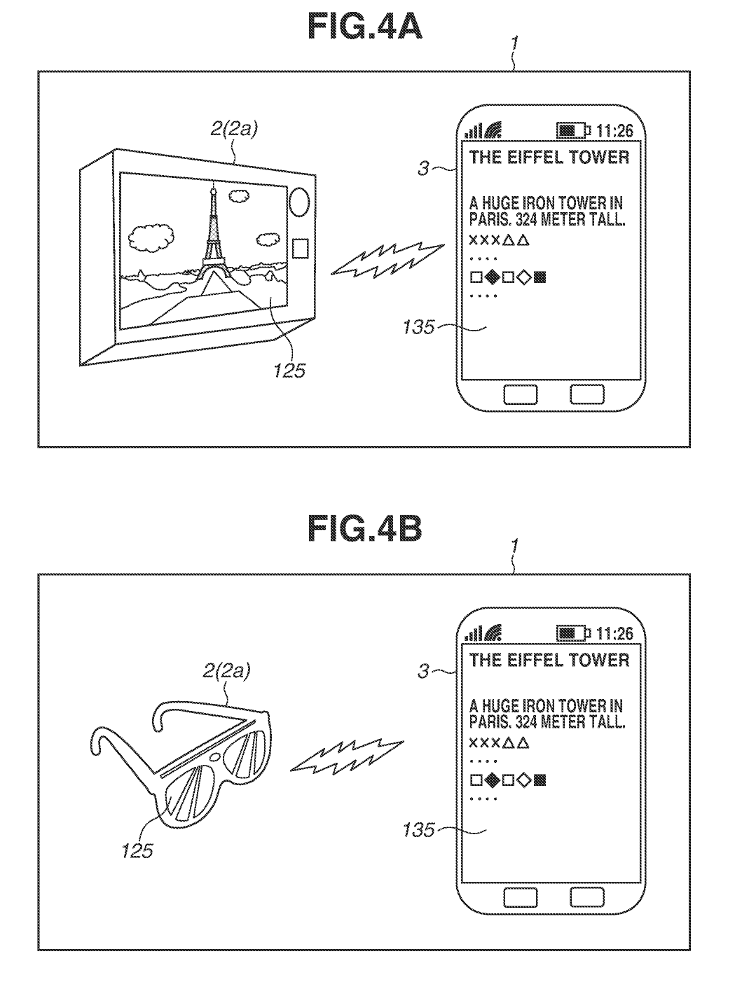

FIGS. 4A and 4B illustrate outlines of examples of processing by the information processing system 1. In the examples in FIGS. 4A and 4B, a single user has the summary information display device 2 and the detailed information display device 3.

FIG. 4A illustrates an example of a usage situation of the information processing system 1 in the case that the summary information display device 2 is a digital camera (hereinbelow, referred to as a digital camera 2a). In the example in FIG. 4A, the display unit 125 is a display screen of the digital camera 2a. Further, the detailed information display device 3 is a smartphone, and the display unit 135 is a screen of the detailed information display device 3 as the smartphone.

An example of a user experience using the information processing system 1 in the example in FIG. 4A is described.

An image captured by the image capturing unit 126 of the digital camera 2a is displayed on the display unit 125. At that time, the summary information display control unit 21 displays the summary information related to an object and an event captured in the image on the display unit 125 by superimposing on the image.

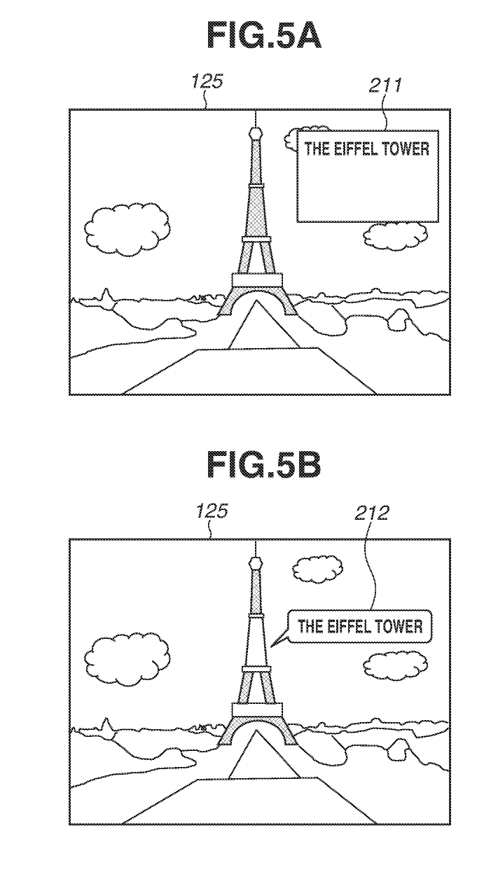

FIGS. 5A and 5B illustrate examples in which the summary information is displayed by being superimposed on an image on the display unit 125 of the example in FIG. 4A. In the example in FIG. 5A, the Eiffel Tower is captured in the image displayed on the display unit 125. The summary information display control unit 21 displays a message “the Eiffel Tower” as the summary information on a position set in the display unit 125 as a notification 211 by superimposing on the image in the display unit 125.

In the example in FIG. 5B, the summary information display control unit 21 displays the message “the Eiffel Tower” as the summary information in a speech balloon from the Eiffel Tower in the image as an annotation 212 by superimposing on the image.

In the both cases in FIGS. 5A and 5B, the detailed information display control unit 31 displays the detailed information of “the Eiffel Tower” which is the object indicated by the summary information displayed on the display unit 125 on the display unit 135 in the detailed information display device 3 as the smartphone. According to the present exemplary embodiment, the information processing system 1 performs following processing regardless of whether the summary information is displayed on the display unit 125 in the summary information display device 2 as a notification or an annotation. In other words, the information processing system 1 displays the detailed information regarding the summary information on the display unit 135 in the detailed information display device 3.

An example of a user experience using the information processing system 1 in the example in FIG. 4B is described.

In the example in FIG. 4B, the summary information display device 2 is an eyeglass type terminal device (hereinbelow, an eyeglass type terminal device 2b). According to the present exemplary embodiment, the eyeglass type terminal device 2b is a see-through type HMD (hereinbelow, the HMD). The HMD displays image information by superimposing on an eyesight of a wearer. The HMD can be classified into an optical see-through type and a video see-through type according to a method for combining an image to be superimposingly displayed on an eyesight. The summary information display device 2 may be any types of HMD.

Assuming that a user wearing the eyeglass type terminal device 2b comes to a place from which the Eiffel Tower can be visually recognized. At that time, the summary information display control unit 21 displays a message “the Eiffel Tower” on the display unit 125 as the summary information by superimposing on an actual landscape as illustrated in FIGS. 5A and 5B. Further, the detailed information display control unit 31 in the detailed information display device 3 as the smartphone displays the detailed information regarding “the Eiffel Tower” on the display unit 135. The user can visually recognize the detailed information of “the Eiffel Tower” displayed on the display unit 135 in the detailed information display device 3 as the smartphone holding in his/her hand.

The example of the user experience using the information processing system 1 according to the present exemplary embodiment is described above.

Processing by the information processing system 1 for realizing the functions described with reference to FIGS. 4A and 4B and FIGS. 5A and 5B is described below.

Assuming that a user captures an image of an actual landscape including the Eiffel Tower by the image capturing unit 126 in the summary information display device 2 which he/her carries.

The summary information generation unit 23 generates the summary information to be presented to the user based on the image captured by the image capturing unit 126. According to the present exemplary embodiment, the summary information generation unit 23 performs image recognition such as abnormality detection and object recognition on the image captured by the image capturing unit 126 and detects the Eiffel Tower. The summary information generation unit 23 generates a message indicating the name of the detected Eiffel Tower as the notification 211 and the annotation 212. Further, the summary information generation unit 23 may detect that the Eiffel Tower is captured based on, for example, positional information of the summary information display device 2 obtained by using the global positioning system (GPS) and an orientation of the summary information generation unit 23 obtained via an orientation sensor and the like. In other words, the summary information generation unit 23 may detect that the Eiffel Tower is captured based on whether the Eiffel Tower enters an image capturing range of the image capturing unit 126 when the summary information generation unit 23 turns to the obtained orientation from the obtained positional information of the summary information display device 2.

The summary information generation unit 23 generates an object such as a drawing and a character string (e.g., a text message and a message image of “the Eiffel Tower”) as the summary information. Further, the summary information generation unit 23 determines a display position of the summary information (e.g., a center position and a position of a starting point of a speech balloon in the display unit 125) when generating the summary information as an annotation. The summary information generation unit 23 determines the display position of the summary information so that, for example, the starting point of the speech balloon comes to the position of the Eiffel Tower detected from the image captured by the image capturing unit 126.

Further, for example, the summary information generation unit 23 may detect a plurality of objects and events from an image captured by the image capturing unit 126 and generate summary information of each of the detected objects and events. In other words, the summary information generation unit 23 may generates a plurality of summary information pieces.

The summary information display control unit 21 displays the summary information generated by the summary information generation unit 23 on the display unit 125 as the notification 211 and the annotation 212 by superimposing on the image captured by the image capturing unit 126 or the actual landscape.

For example, when the display unit 125 is a screen of the digital camera and a screen of the video see-through type HMD, the summary information display control unit 21 generates a combined image obtained by combining an image of the summary information with an image displayed on the screen and displays the combined image on the display unit 125. Further, when the summary information display control unit 21 is a screen of the optical see-through type HMD, the summary information display control unit 21 displays an image of the summary information by optically superimposing on the actual landscape by displaying only the summary information image on the display device.

As described above, the summary information display control unit 21 displays the summary information on the display unit 125 so as to superimpose the summary information on an actual landscape visually recognized by a user and an image captured by the image capturing unit 126.

The summary information generation unit 23 transmits the generated summary information to the detailed information retrieval unit 33 in the detailed information display device 3 via the communication control unit A 22 and the communication control unit B 32.

As described above, the communication control unit A 22 and the communication control unit B 32 control transfer of information between the summary information display device 2 and the detailed information display device 3. The communication control unit A 22 and the communication control unit B 32 can communicate with each other using arbitrary communication method and protocol.

The detailed information retrieval unit 33 retrieves the detailed information regarding the received summary information based on the summary information received from the summary information display device 2. For example, the auxiliary storage device 133 preliminarily stores a list of the detailed information pieces regarding information pieces to be candidates of the various summary information pieces. In such a case, the detailed information retrieval unit 33 retrieves the detailed information corresponding to the received summary information from the list of the detailed information pieces stored in the auxiliary storage device 133.

The detailed information retrieval unit 33 may retrieve the detailed information regarding the received summary information from, for example, a Key-Value type database which stores the detailed information pieces regarding information pieces to be candidates of the various summary information pieces. Further, the detailed information retrieval unit 33 may retrieve the detailed information regarding the received summary information using a Web service, an application, and the like for retrieval via the Internet.

The detailed information retrieval unit 33 transmits the retrieved detailed information to the detailed information display control unit 31. The detailed information display control unit 31 displays the received detailed information on the display unit 135.

As described above, according to the present exemplary embodiment, the summary information display device 2 generates the summary information to be presented to a user based on a visual recognition target of the user such as an image captured by the image capturing unit 126 and an actual landscape in the user's eyesight and presents the summary information to the user by displaying it on the display unit 125. In addition, the detailed information display device 3 determines the detailed information regarding the summary information based on the summary information displayed on the summary information display device 2 and presents the determined detailed information to the user by displaying it on the display unit 135.

Accordingly, the information processing system 1 displays the summary information and the detailed information on the separate devices so that a user can visually recognize the summary information and the detailed information on the separate screens and thus can improve visibility of the summary information and the detailed information. Further, the information processing system 1 detects an object and an event from an image and an actual landscape, generates the summary information about the detected object and event, and thus can present information about the object and the event other than predetermined object and event to a user. Accordingly, the information processing system 1 can improve convenience of a user.

In addition, display of the summary information and browsing and related operation of the detailed information are performed on different devices, and accordingly a system matched with the respective purposes is facilitated to be established. Thus, a system can be easily established which can easily perform visual recognition of the summary information and browsing and the related operation of the detailed information.

According to a second exemplary embodiment, the information processing system 1 detects a gazing motion of a user at the detailed information displayed on the display unit 135 and controls display of the summary information on the display unit 125 when detecting the gazing motion.

A system configuration of the information processing system 1 according to the present exemplary embodiment is similar to that of the first exemplary embodiment. In addition, a hardware configuration of each component in the information processing system 1 is similar to that of the first exemplary embodiment.

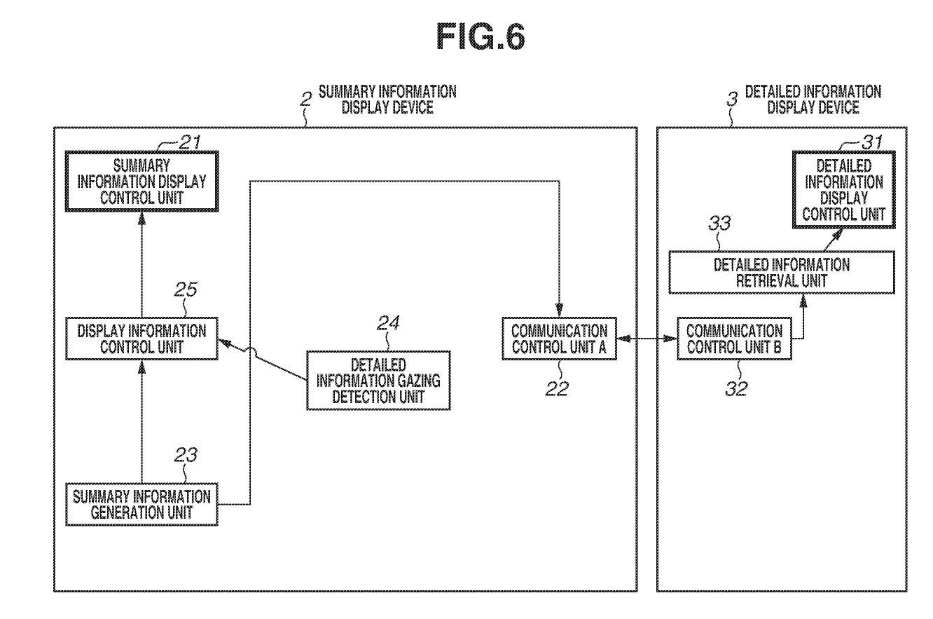

FIG. 6 illustrates an example of a functional configuration of each component in the information processing system 1 according to the present exemplary embodiment.

The functional configuration in FIG. 6 differs from that of the first exemplary embodiment in that the summary information display device 2 further includes a detailed information gazing detection unit 24 and a display information control unit 25. The detailed information gazing detection unit 24 is an example of a second detection unit.

The detailed information gazing detection unit 24 performs detection processing for detecting a gazing motion by a user at the detailed information by determining whether the user is gazing at the detailed information displayed on the display unit 135. When the detailed information gazing detection unit 24 detects gazing by the user at the detailed information, the display information control unit 25 entirely blocks transmission of the summary information generated by the summary information generation unit 23 to the summary information display control unit 21. Accordingly, the summary information display control unit 21 prohibits display of the summary information generated by the summary information generation unit 23 on the display unit 125.

FIG. 7 is an activity diagram illustrating an example of processing by the display information control unit 25.

In step S51, the display information control unit receives the summary information generated by the summary information generation unit 23 from the summary information generation unit 23.

In step S52, the display information control unit determines whether the detailed information gazing detection unit 24 detects gazing by a user at the detailed information. The display information control unit 25 receives, from the detailed information gazing detection unit 24, detailed information gazing information indicating whether gazing by the user at the detailed information is detected. Further, the display information control unit 25 determines whether gazing by the user at the detailed information is detected by the detailed information gazing detection unit 24 based on the received detailed information gazing information.

When determining that gazing by the user at the detailed information is detected by the detailed information gazing detection unit 24 (YES in step S52), the display information control unit 25 terminates the processing in FIG. 7 without transmitting the summary information received in step S51 to the summary information display control unit 21. Accordingly, the display information control unit 25 prohibits display of the summary information received in step S51 on the display unit 125.

Whereas when determining that gazing by the user at the detailed information is not detected by the detailed information gazing detection unit 24 (NO in step S52), the display information control unit 25 advances the processing to step S53.

In step S53, the display information control unit 25 transmits the summary information received in step S51 to the summary information display control unit 21. The summary information display control unit 21 displays the received summary information on the display unit 125 by superimposing on an image and an actual landscape displayed on the display unit 125.

As described above, the information processing system 1 can control superimposing display of the summary information when a user is gazing at the detailed information by the processing in FIG. 7. Accordingly, the information processing system 1 exerts an effect which can improve visibility of the detailed information by controlling display of the summary information displayed on the display unit 125 which may be an obstacle to browsing of the detailed information displayed on the display unit 135. Particularly, the above-described effect is significant when the summary information display device 2 is an HMD.

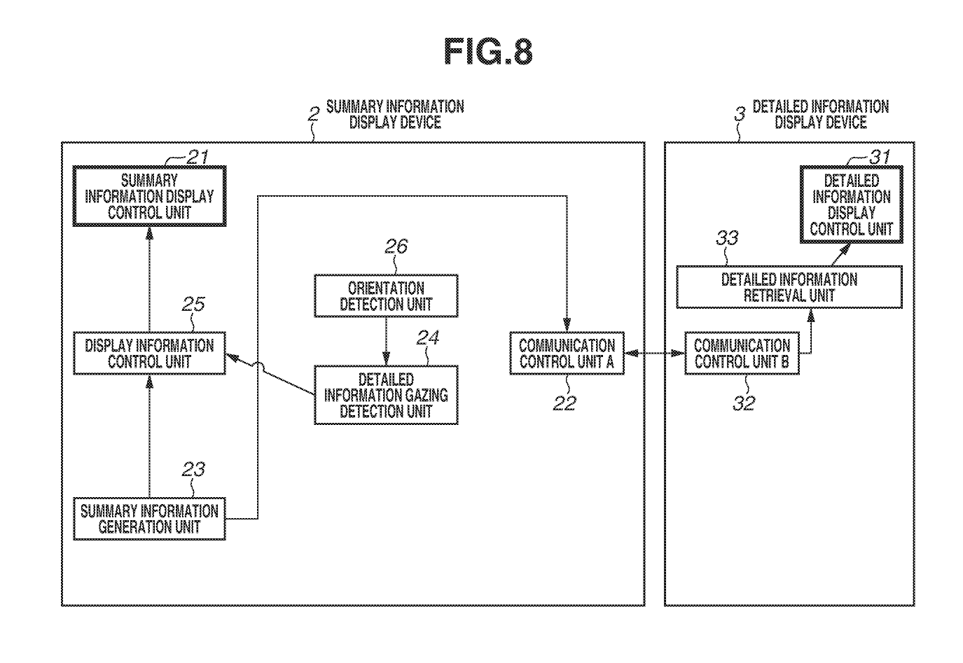

The detailed information gazing detection unit 24 determines whether a user is gazing at the detailed information displayed on the detailed information display control unit 31, and an example of a determination method thereof is described with reference to FIG. 8.

FIG. 8 illustrates an example of a functional configuration of each component in the information processing system 1. The functional configuration in FIG. 8 differs from that in FIG. 6 in that the summary information display device 2 further includes an orientation detection unit 26.

The orientation detection unit 26 detects an orientation of the summary information display device 2. The orientation detection unit 26 outputs the detecting orientation information in a format of, for example, an inclination angle in a pitching direction and acceleration in three axes. The orientation detection unit 26 detects the inclination angle and the acceleration in three axes using, for example, an inclination sensor and a three-axis acceleration sensor in the summary information display device 2.

In the example in FIG. 8, the summary information display device 2 is an HMD, and the orientation detection unit 26 detects the orientation information using the inclination sensor.

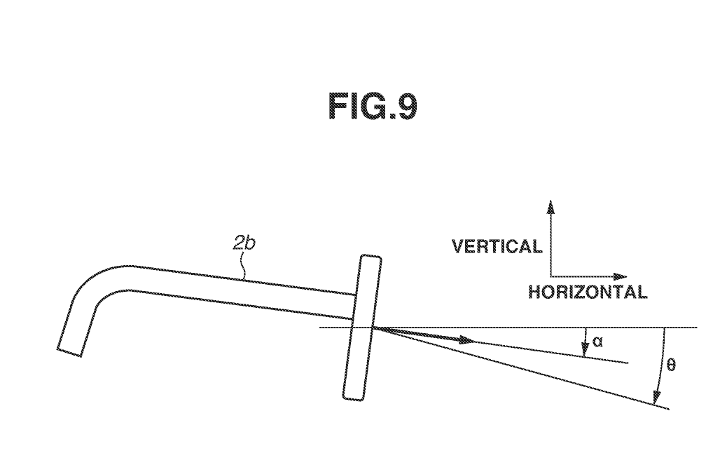

FIG. 9 illustrates an example of processing for detecting an orientation of the summary information display device 2. FIG. 9 illustrates a situation in which the summary information display device 2 as the HMD is viewed from a side. In the example in FIG. 9, a user who wears the summary information display device 2 looks a right direction in FIG. 9. An arrow from the summary information display device 2 in FIG. 9 indicates a straight viewing direction of the user.

A horizontal direction, immediately upward in a vertical direction, and immediately downward in the vertical direction are respectively regarded as 0 (deg) (0 (rad)), +90 (deg) (+n/2 (rad)), and −90 (deg) (−π/2 (rad)). The orientation detection unit 26 detects an inclination of the user's straight viewing direction in the vertical direction as the orientation information of the summary information display device 2. In the example in FIG. 9, the user's straight viewing direction is a downward direction, and thus an angle α has a minus value.

A relationship between an angle α detected by the orientation detection unit 26 and whether a user is gazing at the detailed information is described.

It is assumed that the angle α is less than a set angle θ (<0) in a situation in which a user is gazing at the detailed information display control unit 31 in the detailed information display device 3.

α<θ (Expression 1)

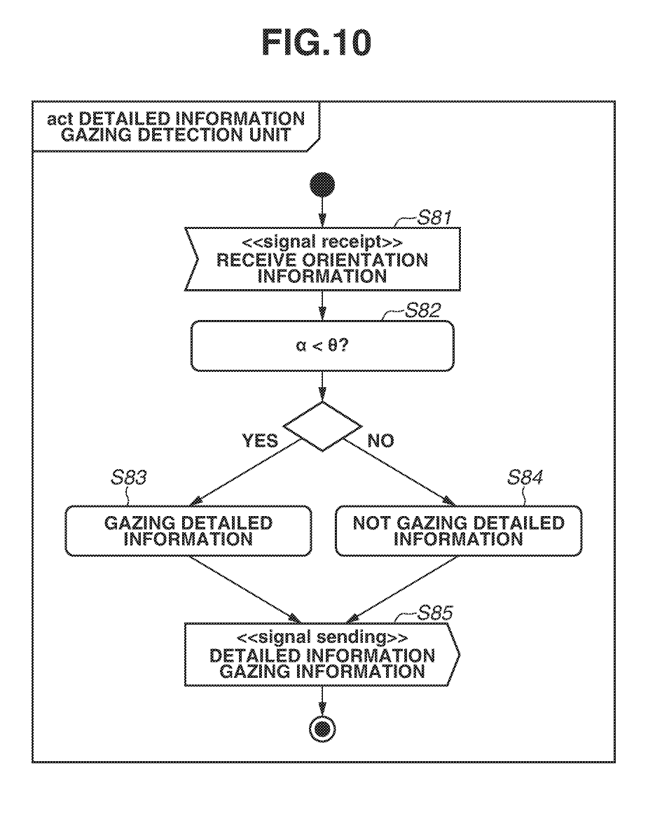

An example of processing by the detailed information gazing detection unit 24 in this case is described with reference to FIG. 10.

FIG. 10 is an activity diagram illustrating an example of the processing by the detailed information gazing detection unit 24.

In step S81, the detailed information gazing detection unit 24 receives the orientation information (the inclination angle α) of the summary information display device 2 detected by the orientation detection unit 26 from the orientation detection unit 26.

In step S82, the detailed information gazing detection unit 24 determines whether the angle α received in step S81 is less than the set angle θ. In other words, the detailed information gazing detection unit 24 determines whether the angle α received in step S81 satisfies the expression 1. When determining that the angle α received in step S81 is less than the set angle θ (YES in step S82), the detailed information gazing detection unit 24 advances the processing to step S83. Whereas when determining that the angle α received in step S81 is greater than or equal to the set angle θ (NO in step S82), the detailed information gazing detection unit 24 advances the processing to step S84.

In step S83, the detailed information gazing detection unit 24 regards as that the user is gazing at the detailed information displayed on the display unit 135 and determines that a gazing motion by the user at the detailed information is detected.

In step S84, the detailed information gazing detection unit 24 regards as that the user is not gazing at the detailed information displayed on the display unit 135 and determines that a gazing motion by the user at the detailed information is not detected.

In step S85, the detailed information gazing detection unit 24 transmits, to the display information control unit 25, a result of the processing in step S83 or step S84 as the detailed information gazing information indicating whether a gazing motion by the user at the detailed information is detected.

As described above, according to the present exemplary embodiment, the orientation detection unit 26 detects the orientation information from which a situation of gazing at the detailed information can be estimated, and it is determined, from the orientation information, whether the user of the summary information display device 2 is gazing at the detailed information displayed on the display unit 135.

When a user gazes at a smartphone or the like, a line of sight of the user on the smartphone is directed naturally downward. Thus, when a user of the summary information display device 2 gazes at the detailed information displayed on the display unit 135 in the detailed information display device 3 as the smartphone, the information processing system 1 can control superimposing display of the summary information which may be an obstacle to browsing of the detailed information by the above-described processing.

The orientation detection unit 26 detects an orientation of the summary information display device 2 using the inclination sensor in the summary information display device 2, however, may detect an orientation using another sensor such as the three-axis acceleration sensor in the summary information display device 2.

According to the second exemplary embodiment, the information processing system 1 detects an orientation of the summary information display device 2 and detects a gazing motion by a user at the detailed information based on the detected orientation. According to a third exemplary embodiment, the information processing system 1 detects an orientation of the detailed information display device 3 and detects a gazing motion by a user at the detailed information based on the detected orientation.

A system configuration of the information processing system 1 according to the present exemplary embodiment is similar to that of the first exemplary embodiment. In addition, a hardware configuration of each component in the information processing system 1 is similar to that of the first exemplary embodiment.

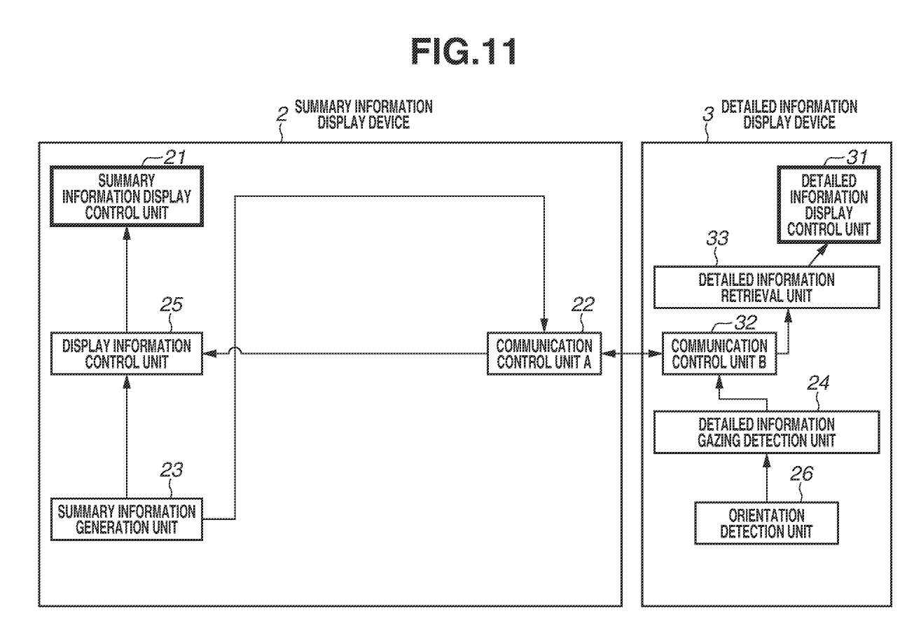

FIG. 11 illustrates an example of a functional configuration of each component in the information processing system 1 according to the present exemplary embodiment. In FIG. 8, the detailed information gazing detection unit 24 and the orientation detection unit 26 are included in the summary information display device 2. In the example in FIG. 11, the detailed information gazing detection unit 24 and the orientation detection unit 26 are included in the detailed information display device 3. The orientation detection unit 26 according to the present exemplary embodiment detects not an orientation of the summary information display device 2 but an orientation of the detailed information display device 3. The detailed information gazing detection unit 24 may be included in the summary information display device 2.

According to the present exemplary embodiment, the detailed information display device 3 is a smartphone. The orientation detection unit 26 detects an angle between a normal line and a vertical axis of the display unit 135 in the detailed information display device 3 as the orientation information of the detailed information display device 3. An angle to be detected is 0 (deg) (0 (rad)) when the display unit 135 is directed to the immediately upward in the vertical direction, has a plus value when the display unit 135 is inclined toward a front side with respect to a user, and has a minus value when the display unit 135 is inclined toward an opposite side with respect to the user. The orientation detection unit 26 obtains the orientation information of the detailed information display device 3 via the inclination sensor, the three-axis acceleration sensor, and the like of the detailed information display device 3.

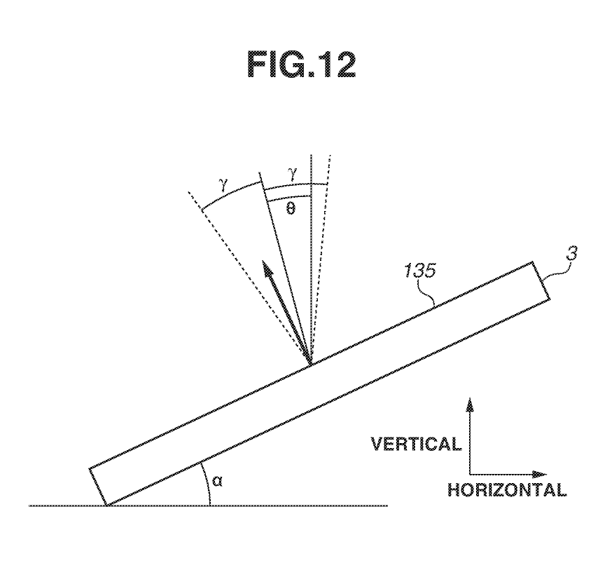

A relationship between an angle detected by the orientation detection unit 26 and whether a user of the summary information display device 2 is gazing at the detailed information is described with reference to FIG. 12.

FIG. 12 illustrates an example of processing for detecting an orientation of the detailed information display device 3. FIG. 12 illustrates a situation in which the detailed information display device 3 as the smartphone is viewed from a side. The display unit 135 is arranged on an upper side in the vertical direction. In the example in FIG. 12, a user exists on a left side of a screen, and the detailed information display device 3 is in an orientation in which the display unit 135 is inclined toward a front direction with respect to the user. An arrow from the display unit 135 in FIG. 12 indicates a normal line of the display unit 135. An angle between and the normal line and the vertical axis of the display unit 135 is a.

It is assumed that the angle α satisfies a following expression 2 in a situation in which a user is gazing at the detailed information display control unit 31 in the detailed information display device 3.

θ−γ<α<θ+γ (Expression 2)

Values δ (>0) and γ (>0) in the expression 2 are set in advance. The values θ and γ are calculated by a biomechanical method so as to reduce a physical burden on a user caused by a browsing orientation. In addition, the values θ and γ can be experimentally calculated by sensory evaluation and the like, and are, for example, θ=40 [deg], and γ=15 [deg].

Processing by the detailed information gazing detection unit 24 in this case is described with reference to FIG. 10. The processing in step S82 in FIG. 10 is different compared to that in the second exemplary embodiment.

In step S82, the detailed information gazing detection unit 24 determines whether the angle α received in step S81 satisfied the expression 2. When determining that the angle α received in step S81 satisfies the expression 2, the detailed information gazing detection unit 24 advances the processing to step S83. Whereas when determining that the angle β received in step S81 does not satisfy the expression 2, the detailed information gazing detection unit 24 advances the processing to step S84.

As described above, according to the present exemplary embodiment, the orientation detection unit 26 detects the orientation information of the detailed information display device 3 when a user is gazing at the detailed information and determines whether the user is gazing at the detailed information from the detected orientation information.

When a user gazes at a smartphone and the like, a screen of the smartphone is inclined naturally toward the user side. Thus, the information processing system 1 can control display of the summary information which may be an obstacle to browsing of the detailed information based on gazing of a user at the detailed information display device as the smartphone by the above-described processing. Accordingly, the information processing system 1 can improve visibility of the detailed information.

According to the present exemplary embodiment, it is assumed that a situation in which a user is gazing at a smartphone is a situation satisfying the expression 2. However, a situation in which a user is gazing at a smartphone may be assumed as, for example, a situation in which an output value of each axis on the three-axis acceleration sensor in the detailed information display device 3 is included within a set range.

According to the second and the third exemplary embodiments, the information processing system 1 detects a gazing motion by a user at the detailed information using the orientation information of the summary information display device 2 or the detailed information display device 3. According to a fourth exemplary embodiment, the information processing system 1 detects a gazing motion by a user at the detailed information based on a relative positional relationship of the summary information display device 2 and the detailed information display device 3.

A system configuration of the information processing system 1 according to the present exemplary embodiment is similar to that of the first exemplary embodiment. In addition, a hardware configuration of each component in the information processing system 1 is similar to that of the first exemplary embodiment.

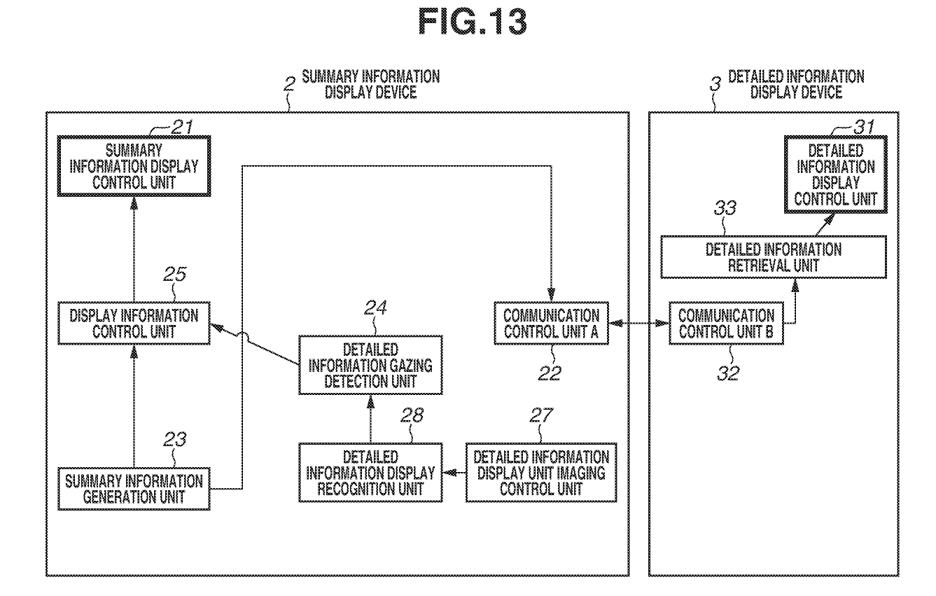

FIG. 13 illustrates an example of a functional configuration of each component in the information processing system 1 according to the present exemplary embodiment. In the example in FIG. 13, the summary information display device 2 further includes a detailed information display unit imaging control unit 27 and a detailed information display recognition unit 28 compared to that in FIG. 6.

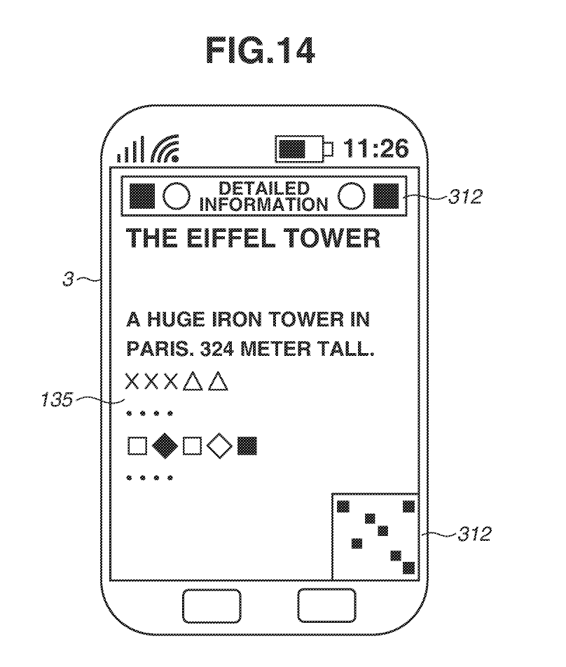

According to the present exemplary embodiment, the detailed information display control unit 31 displays a marker 312 on the display unit 135 in addition to the display of the detailed information on the display unit 135. This situation is illustrated in FIG. 14. In the example in FIG. 14, the markers 312 are a message as “detailed information” and a two-dimensional code. The marker 312 may be an arbitrary one such as a character string, a design, blinking character string and design, and a moving image as long as they are recognizable by the detailed information display recognition unit 28 and may not be necessarily recognizable by a user. The marker 312 may be, for example, an electronic watermark used in a printing medium and a marker having a wavelength outside a visible wavelength region.

The image capturing unit 126 is arranged so as to be able to capture an image of the display unit 135 when a user is gazing at the detailed information displayed on the display unit 135. The image capturing unit 126 according to the present exemplary embodiment is, for example, a camera for capturing an image of a user's eyesight included in the summary information display device 2 as the HMD.

The detailed information display unit imaging control unit 27 transmits an image captured via the image capturing unit 126 to the detailed information display recognition unit 28.

The detailed information display recognition unit 28 detects the marker 312 from the image captured by the detailed information display unit imaging control unit 27. When the summary information display device 2 and the detailed information display device 3 are in a positional relationship in which the image capturing unit 126 can capture an image of the display unit 135, the marker 312 is detected from the image captured by the detailed information display unit imaging control unit 27. Further, the detailed information display recognition unit 28 transmits a detected result to the detailed information gazing detection unit 24 as detailed information display recognition information.

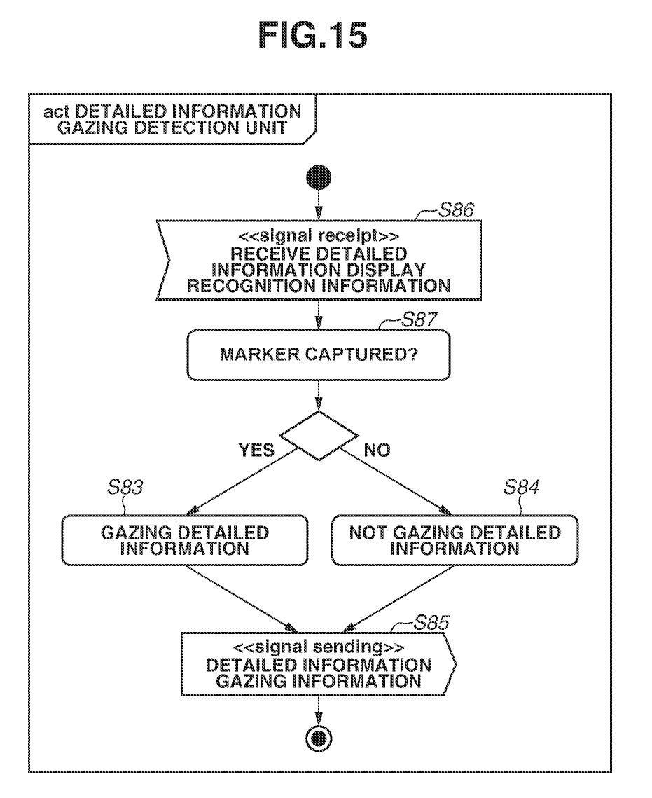

FIG. 15 is an activity diagram illustrating an example of processing by the detailed information gazing detection unit 24 according to the present exemplary embodiment. The processing in FIG. 15 differs from that in FIG. 10 in that processing in step S86 and step S87 are included respectively instead of the processing in step S81 and step S82.

In step S86, the detailed information gazing detection unit 24 receives the detailed information display recognition information indicating the result of the detection processing of the marker 312 from the detailed information display recognition unit 28.

In step S87, the detailed information gazing detection unit 24 determines whether the marker 312 exists in the image captured by the detailed information display unit imaging control unit 27 based on the detailed information display recognition information received in step S86. When determining that the marker 312 exists in the image captured by the detailed information display unit imaging control unit 27 (YES in step S87), the detailed information gazing detection unit 24 advances the processing to step S83. Whereas when determining that the marker 312 does not exist in the image captured by the detailed information display unit imaging control unit 27 (NO in step S87), the detailed information gazing detection unit 24 advances the processing to step S84.

As described above, according to the present exemplary embodiment, the information processing system 1 determines whether a user is gazing at the detailed information based on whether the display unit 135 for displaying the detailed information exists in an image captured by the image capturing unit 126 in the summary information display device 2.

When a user gazes at a smartphone or the like, a screen of the smartphone is included in the user's eyesight. Thus, the information processing system 1 can control display of the summary information which may be an obstacle to browsing of the detailed information based on a natural motion by a user to gaze at a smartphone by the above-described processing. Accordingly, the information processing system 1 can improve visibility of the detailed information.

According to the present exemplary embodiment, the detailed information display recognition unit 28 determines whether the display unit 135 exists in an image by recognizing the marker 312. However, for example, when the detailed information display control unit 31 does not display the marker 312, the detailed information display recognition unit 28 may determine whether the display unit 135 exists in an image by recognizing the display unit 135 itself.

The detailed information display recognition unit 28 can recognize the display unit 135 by recognizing, for example, a button and a design around the display unit 135 in the detailed information display device 3.

According to the fourth exemplary embodiment, the information processing system 1 detects a gazing motion by a user at the detailed information based on whether an image of the display unit 135 is captured by the image capturing unit 126. According to a fifth exemplary embodiment, the information processing system 1 detects a gazing motion by a user at the detailed information based on whether an image of the summary information display device 2 is captured by the image capturing unit 136.

A system configuration of the information processing system 1 according to the present exemplary embodiment is similar to that of the first exemplary embodiment. In addition, a hardware configuration of each component in the information processing system 1 is similar to that of the first exemplary embodiment.

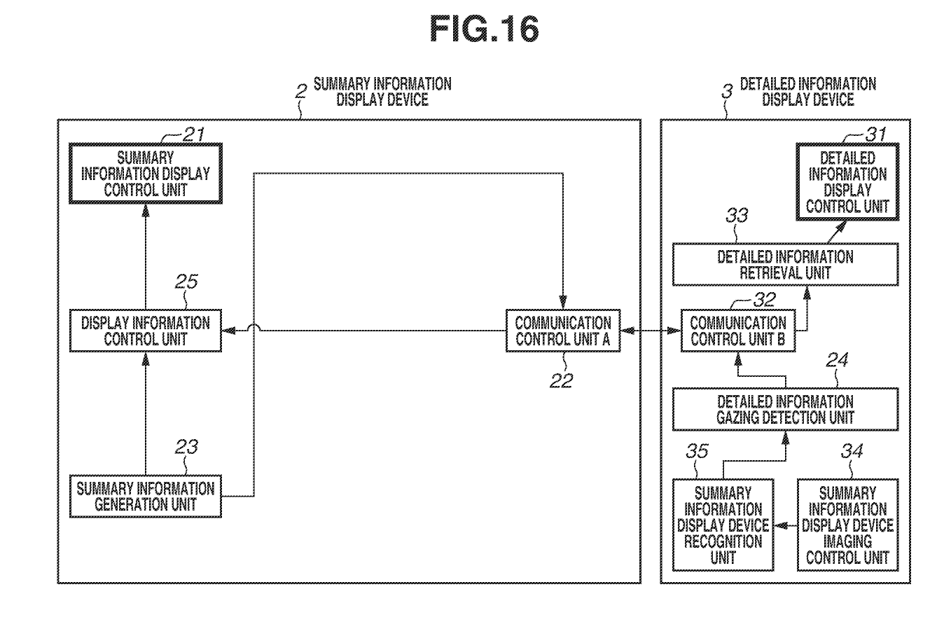

FIG. 16 illustrates an example of a functional configuration of each component in the information processing system 1. The example in FIG. 16 differs from that in FIG. 13 in that the detailed information gazing detection unit 24 is included not in the summary information display device 2 but in the detailed information display device 3. In addition, a summary information display device imaging control unit 34 and a summary information display device recognition unit 35 are included in the detailed information display device 3 instead of that the detailed information display unit imaging control unit 27 and the detailed information display recognition unit 28 are not included in the summary information display device 2. The summary information display device recognition unit 35 may be included in the summary information display device 2.

The summary information display device imaging control unit 34 captures an image of the summary information display device 2 via the image capturing unit 136.

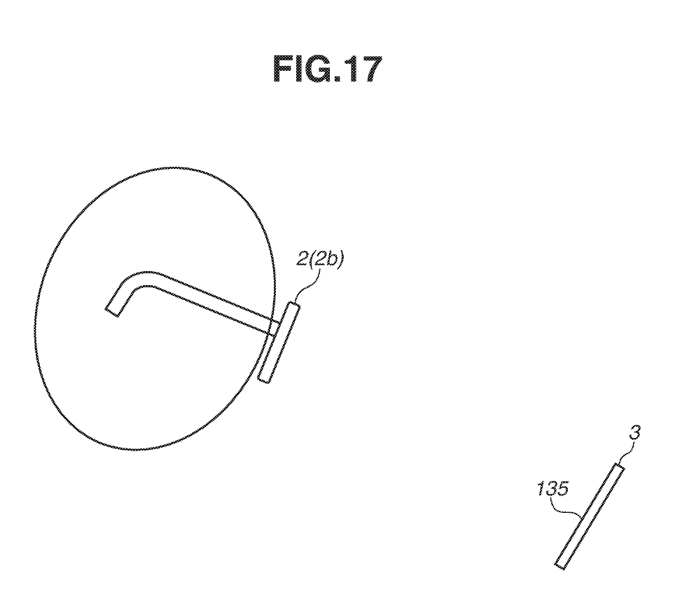

The image capturing unit 136 is arranged so as to be able to capture an image of the summary information display device 2 worn by a user when the user is gazing at the detailed information displayed on the display unit 135. The image capturing unit 136 according to the present exemplary embodiment is a camera installed on a side of the display unit 135 in the detailed information display device 3. According to the present exemplary embodiment, a user wears the summary information display device 2 as an HMD. FIG. 17 illustrates a situation when a user is “gazing at the detailed information” in this case.

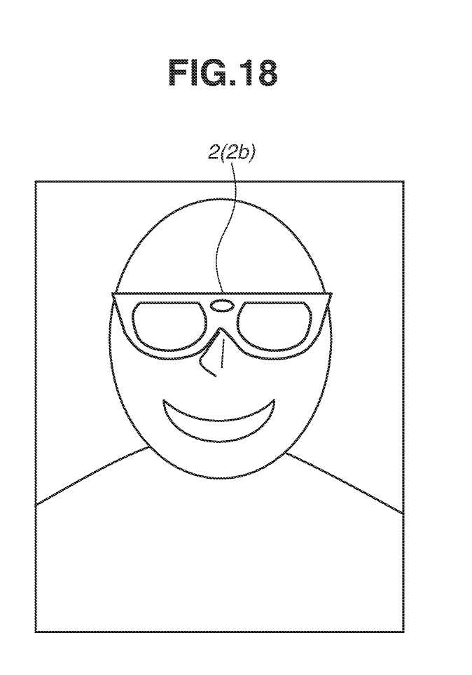

FIG. 17 illustrates an example of a usage aspect of the information processing system 1 according to the present exemplary embodiment. In FIG. 17, when the user is gazing at the detailed information, an image to be captured by the image capturing unit 136 will be, for example, an image as illustrated in FIG. 18. Thus, according to the present exemplary embodiment, the information processing system 1 determines whether a user is gazing at the detailed information by recognizing the summary information display device 2 from an image captured by the image capturing unit 136.

The summary information display device imaging control unit 34 transmits an image captured via the image capturing unit 136 to the summary information display device recognition unit 35. The summary information display device recognition unit 35 detects the summary information display device 2 from the transmitted image. When the summary information display device 2 and the detailed information display device 3 are in a positional relationship in which the image capturing unit 136 can capture an image of the summary information display device 2, the summary information display device 2 is detected from the image captured by the summary information display device imaging control unit 34. The summary information display device recognition unit 35 transmits a result of the performed detection processing to the detailed information gazing detection unit 24 as summary information display device recognition information indicating whether the summary information display device 2 is detected.

FIG. 19 is an activity diagram illustrating an example of processing by the detailed information gazing detection unit 24. The processing in FIG. 19 differs from that in FIG. 15 in that processing in step S861 and step S871 are included respectively instead of the processing in step S86 and step S87.

In step S861, the detailed information gazing detection unit 24 receives the summary information display device recognition information from the summary information display device recognition unit 35.

In step S871, the detailed information gazing detection unit 24 determines whether the summary information display device 2 exists in the image captured by the image capturing unit 136 based on the summary information display device recognition information received in step S861. When determining that the summary information display device 2 exists in the image captured by the image capturing unit 136 (YES in step S871), the detailed information gazing detection unit 24 advances the processing to step S83. Whereas when determining that the summary information display device 2 does not exist in the image captured by the image capturing unit 136 (NO in step S871), the detailed information gazing detection unit 24 advances the processing to step S84.

As described above, according to the present exemplary embodiment, the information processing system 1 determines whether a user is gazing at the detailed information based on whether the summary information display device 2 exists in an image captured by the image capturing unit 136 in the detailed information display device 3.

When a user gazes at the detailed information display device 3 in a situation as illustrated in FIG. 17, the summary information display device 2 is included in the image captured by the image capturing unit 136 in the detailed information display device 3. Thus, the information processing system 1 can control superimposing display of the summary information which may be an obstacle to browsing of the detailed information based on a natural motion by a user to gaze at a smartphone by the above-described processing. Accordingly, the information processing system 1 can improve visibility of the detailed information.

According to the present exemplary embodiment, the information processing system 1 uses information about whether the summary information display device 2 is included in an image captured by the summary information display device imaging control unit 34 to determine whether a user is gazing at the detailed information. However, the information processing system 1 may use the further detailed information. For example, the information processing system 1 may use coordinates of a plurality of points (regions) on the summary information display device 2 in an image. The information processing system 1 can more precisely check a relative positional relationship of the summary information display device 2 and the detailed information display device 3 based on whether each of these points is within a coordinate range set respectively.

According to the fifth exemplary embodiment, the information processing system 1 detects a gazing motion by a user at the detailed information based on whether an image of the summary information display device 2 is captured by the image capturing unit 136. According to a sixth exemplary embodiment, the information processing system 1 detects a gazing motion by a user at the detailed information based on whether an image of a user's face is captured by the image capturing unit 136. In other words, the information processing system 1 detects a gazing motion by a user at the detailed information based on a relative positional relationship of a user's face and the detailed information display device 3.

A system configuration of the information processing system 1 according to the present exemplary embodiment is similar to that of the first exemplary embodiment. In addition, a hardware configuration of each component in the information processing system 1 is similar to that of the first exemplary embodiment.

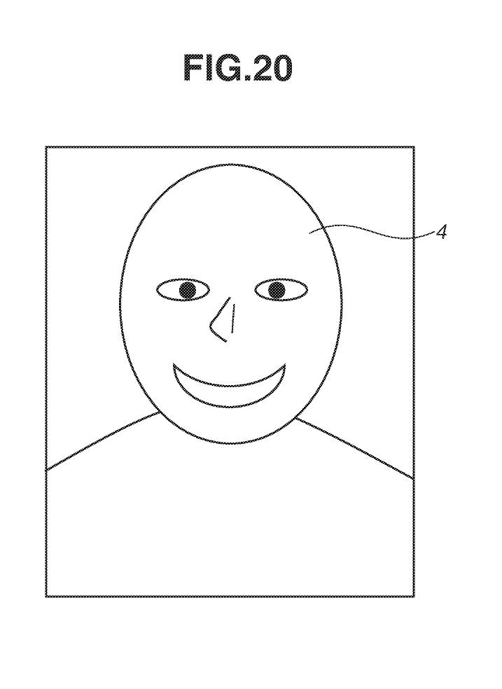

When the summary information display device 2 is not an HMD and the like, a user does not always wear the summary information display device 2. As illustrated in FIG. 4A, the summary information display device 2 may be a digital camera in some cases. In such a case, an image to be captured via the image capturing unit 136 is, for example, an image as illustrated in FIG. 20.

Thus, according to the present exemplary embodiment, the information processing system 1 determines whether a user is gazing at the detailed information based on whether a user's face 4 exists in an image captured via the image capturing unit 136.

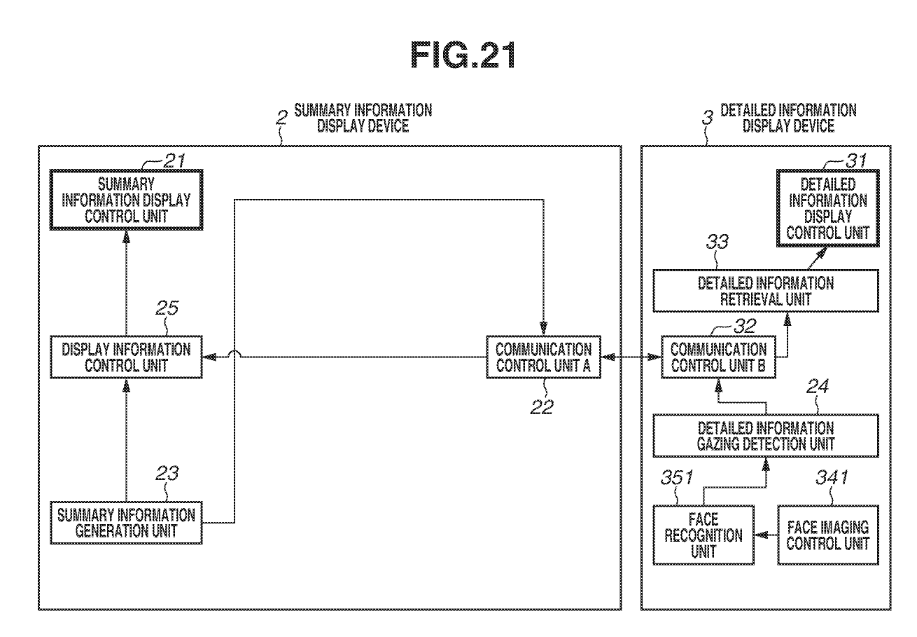

FIG. 21 illustrates an example of a functional configuration of each component in the information processing system 1 according to the present exemplary embodiment. The functional configuration in FIG. 21 differs from that in FIG. 16 in that the detailed information display device 3 includes a face imaging control unit 341 and a face recognition unit 351 respectively instead of the summary information display device imaging control unit 34 and the summary information display device recognition unit 35.

The face imaging control unit 341 captures an image via the image capturing unit 136 and transmits the captured image to the face recognition unit 351. The image capturing unit 136 is arranged so as to be able to capture an image of the user's face 4 when the user is gazing at the detailed information displayed on the display unit 135. The image capturing unit 136 is a camera installed on a side of the display unit 135 in the detailed information display device 3.

The face recognition unit 351 detects the user's face 4 from the image captured by the face imaging control unit 341. When the image capturing unit 136 is in a positional relationship capable of capturing an image of the face 4, the face 4 is detected from the image captured by the face imaging control unit 341. The face recognition unit 351 transmits a result of the performed detection processing to the detailed information gazing detection unit 24 as face recognition information indicating whether the face 4 is detected.

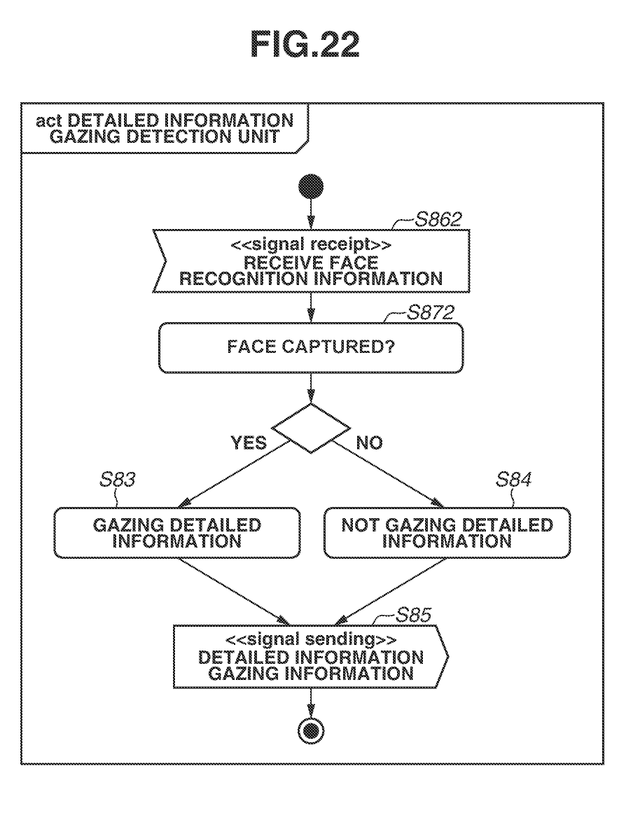

FIG. 22 is an activity diagram illustrating an example of processing by the detailed information gazing detection unit 24. The processing in FIG. 22 differs from that in FIG. 19 in that processing in step S862 and step S872 are included respectively instead of the processing in step S861 and step S871.

In step S862, the detailed information gazing detection unit 24 receives the face recognition information from the face recognition unit 351.

In step S872, the detailed information gazing detection unit 24 determines whether the face 4 exists in an image captured by the face imaging control unit 341 based on the face recognition information received in step S862. When determining that the face 4 exists in the image captured by the face imaging control unit 341 (YES in step S872), the detailed information gazing detection unit 24 advances the processing to step S83. Whereas when determining that the face 4 does not exist in the image captured by the face imaging control unit 341 (NO in step S872), the detailed information gazing detection unit 24 advances the processing to step S84.

As described above, according to the present exemplary embodiment, the information processing system 1 detects a gazing motion by a user at the detailed information based on whether an image of the user's face is captured by the image capturing unit 136.

When a user gazes at the detailed information display device 3 in a situation as illustrated in FIG. 17, the user's face 4 is included in an image captured via the image capturing unit 136 in the detailed information display device 3. Thus, the information processing system can control superimposing display of the summary information which may be an obstacle to browsing of the detailed information based on a natural motion by a user to gaze at a smartphone by the above-described processing. Accordingly, the information processing system 1 can improve visibility of the detailed information.

According to the present exemplary embodiment, the face recognition unit 351 recognizes the user's face 4, however, may recognize an organ such as an eye, a nose, and a mouth constituting the face 4 without necessarily limiting to the face 4.

According to the present exemplary embodiment, the information processing system 1 uses information about whether the face 4 is included in an image captured via the image capturing unit 136 to determine whether a user is gazing at the detailed information. However, the information processing system 1 may use the further detailed information. The information processing system 1 may use, for example, information about a size and an orientation of the face 4 of a user in an image captured by the image capturing unit 136 to determine whether the user is gazing at the detailed information.

The information processing system 1 may directly estimate the information about the size and the orientation of the face 4 in an image and may estimate them using, for example, coordinates of a plurality of points (regions) on the face 4 in the image. The information processing system can more precisely check a relative position and orientation of the face 4 and the detailed information display device 3 based on whether each of these points is within a coordinate range set respectively.

The information processing system 1 may further determine whether a user is gazing at the detailed information using a line-of-sight direction of the user estimated from the face 4 captured in the image. The information processing system 1 recognizes, for example, an organ, “eye”, on the face 4 and then can estimate the line-of-sight direction of the user from positions of an iris and a pupil in the “eye”. When determining that the estimated line-of-sight direction is directed toward the display unit 135, the information processing system 1 can determine that the user is gazing at the detailed information.

According to a seventh exemplary embodiment, the information processing system 1 detects a gazing motion by a user at the detailed information by detecting an operation performed on the detailed information display device 3.

A system configuration of the information processing system 1 according to the present exemplary embodiment is similar to that of the first exemplary embodiment. In addition, a hardware configuration of each component in the information processing system 1 is similar to that of the first exemplary embodiment.

The detailed information that a user views via the display unit 135 is the detailed information output from the detailed information display control unit 31. However, a physical size of the display unit 135 is limited, and only a part of the detailed information can be displayed in some cases. In such a case, a user may perform an operation on the detailed information displayed on the display unit 135 via the input unit 134 to scroll a screen displayed on the display unit 135. In addition, when a plurality of the detailed information pieces is displayed on the display unit 135, a user wants to select one detailed information piece to be displayed while viewing the screen in some cases.

An operation method for immediately responding to an operation by a user on the input unit 134 is referred to as an interactive operation.

It can be assumed that a user is gazing at the detailed information when the information processing system 1 performs an interactive operation to the user via the detailed information displayed on the display unit 135. Thus, according to the present exemplary embodiment, the information processing system 1 detects an operation on the detailed information displayed on the display unit 135 and, when detecting the operation, determines that the user is gazing at the detailed information.

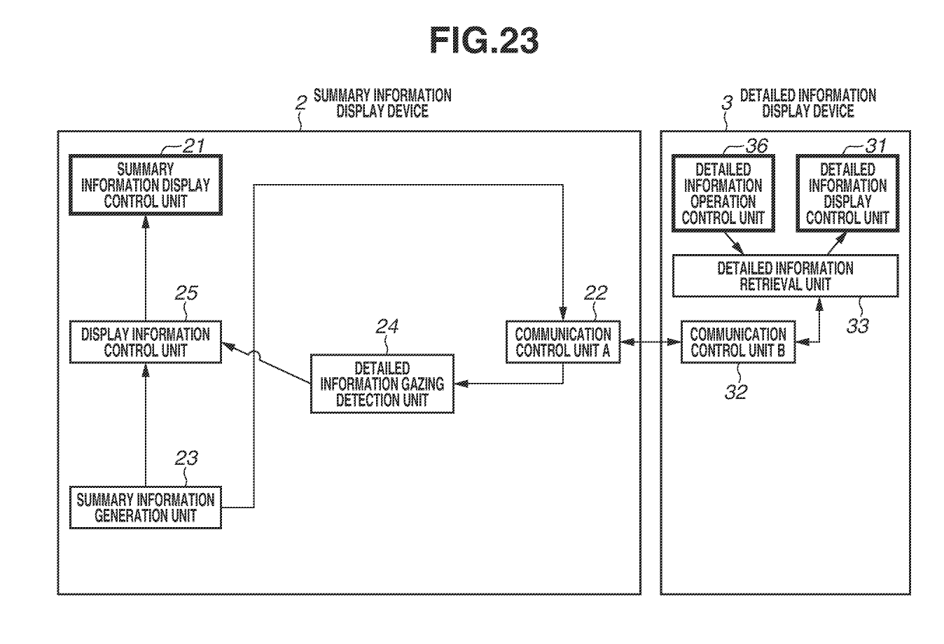

FIG. 23 illustrates an example of a functional configuration of each component in the information processing system 1 according to the present exemplary embodiment. The functional configuration in FIG. 23 differs from that in FIG. 6 in that the detailed information display device 3 further includes a detailed information operation control unit 36.

The detailed information operation control unit 36 performs an interactive operation to a user via the input unit 134.

The detailed information operation control unit 36 detects an operation by a user via the input unit 134 (e.g., pressing of a hard button and a gesture operation on a touch panel).

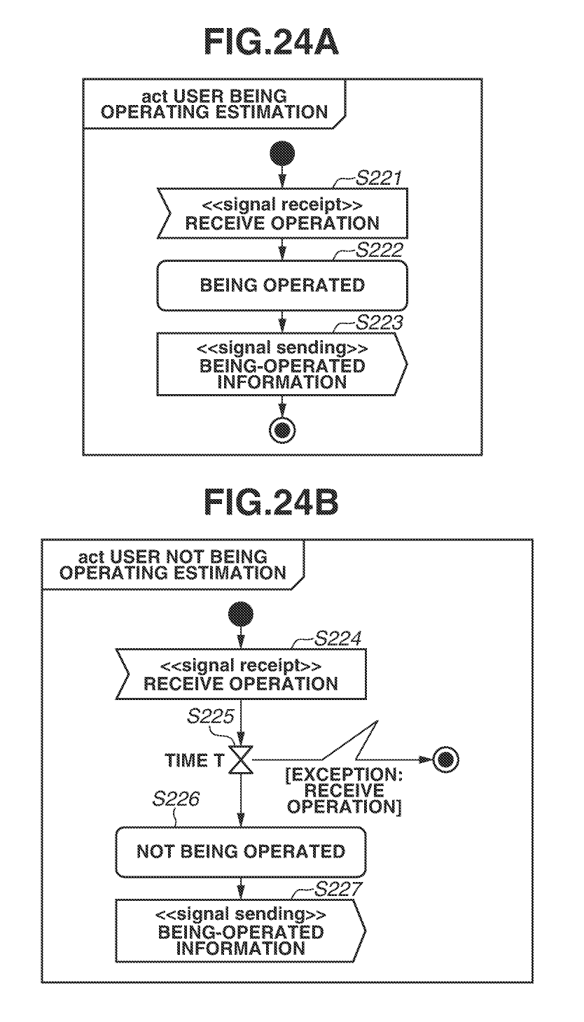

The detailed information operation control unit transmits operation information corresponding to the operation received via the input unit 134 to the detailed information retrieval unit 33. The operation information is information to be a trigger to start subsequent processing when some operation is performed. The operation information is called in response to an operation. The detailed information retrieval unit 33 estimates whether a user is performing an operation based on the transmitted operation information. A flow of the processing is described below with reference to FIGS. 24A and 24B.

FIGS. 24A and 24B are activity diagrams illustrating an example of being-operating estimation processing. According to the present exemplary embodiment, the processing in FIGS. 24A and 24B is executed by the detailed information retrieval unit 33, however, may be executed by other components such as the detailed information operation control unit 36. After executing the processing in FIGS. 24A and 24B, the detailed information retrieval unit 33 transmits a processing result to the detailed information gazing detection unit 24.

The processing in FIG. 24A is an example of processing for estimating as “being operated”. The processing in FIG. 24B is an example of processing for estimating as “not being operated”.

According to the present exemplary embodiment, when a user performs an operation, the detailed information retrieval unit 33 performs the processing in FIG. 24A and notifies the detailed information gazing detection unit 24 of “being operated” by the user. Further, when a series of operations by the user is completed, the detailed information retrieval unit 33 performs the processing in FIG. 24B and notifies the detailed information gazing detection unit 24 of “not being operated”.

The processing in FIG. 24A is described.

In step S221, the detailed information retrieval unit 33 receives the operation information corresponding to an operation by a user via the input unit 134 received by the detailed information operation control unit 36 from the detailed information operation control unit 36. The detailed information retrieval unit 33 may receive the operation information corresponding to only a predetermined operation in step S221. For example, the detailed information retrieval unit 33 may receive only the operation information corresponding to a “tap” operation and a “swipe” operation on the input unit 134 as the touch panel and may not receive the operation information corresponding to other operations such as a “flick” operation.

In step S222, the detailed information retrieval unit 33 estimates a current situation at to be being operated by the user via the input unit 134.

In step S223, the detailed information retrieval unit 33 transmits information indicating “being operated” to the detailed information gazing detection unit 24 as being-operated information indicating whether the input unit 134 is being operated.

The processing in FIG. 24B is described.

It is assumed that a period in which a user is operating includes not only a moment when performing an individual operation but also a period when performing a series of operations and a time for checking an operation result. Thus, according to the present exemplary embodiment, it is determined that an operating period is terminated in the case that a subsequent operation is not performed until a set time T elapses after a series of operations is performed. In other words, when a next operation is performed before the elapse of the time T after a certain operation is performed, it is regarded that the operating period is continues.

In step S224, the detailed information retrieval unit 33 receives the operation information from the detailed information operation control unit 36 as with step S221.

In step S225, the detailed information retrieval unit 33 waits for the elapse of the time T set from a time when the operation information is last received in step S224. In the case that the detailed information retrieval unit 33 waits without receiving new operation information until the time T elapses which is set from the time when the operation information is last received in step S224, the detailed information retrieval unit 33 advances the processing to step S226. Whereas when new operation information is received from the detailed information operation control unit 36 while waiting, the detailed information retrieval unit 33 starts to wait for the elapse of the time T from the received time. In other words, the detailed information retrieval unit 33 performs the processing in step S225 again from the beginning.

In step S226, the detailed information retrieval unit 33 estimates the current situation at “not being operated” in which an operation by the user is not performed.

In step S227, the detailed information retrieval unit 33 transmits information indicating that the current situation is “not being operated” to the detailed information gazing detection unit 24 as the being-operated information.

As described above, the detailed information retrieval unit 33 transmits the being-operated information indicating as “being operated” every time an operation is performed by a user via the display unit 135 and the input unit 134 to the detailed information gazing detection unit 24 by the processing in FIG. 24A. Further, the detailed information retrieval unit 33 transmits the being-operated information indicating as “not being operated” when a series of operations is completed to the detailed information gazing detection unit 24 by the processing in FIG. 24B.

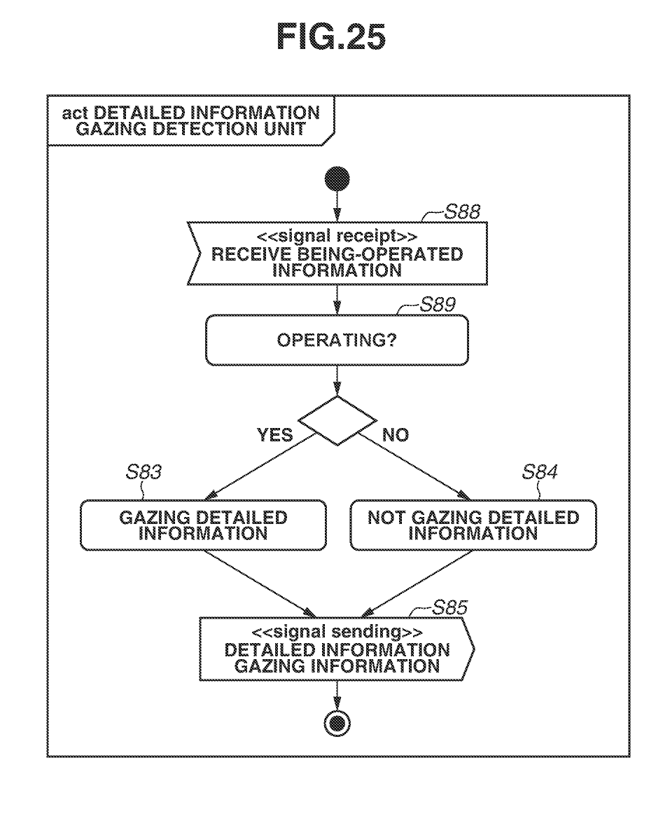

FIG. 25 is an activity diagram illustrating an example of processing by the detailed information gazing detection unit 24 according to the present exemplary embodiment. The processing in FIG. 25 differs from that in FIG. 10 in that processing in step S88 and step S89 are included respectively instead of the processing in step S81 and step S82.

In step S88, the detailed information gazing detection unit 24 receives the being-operated information from the detailed information retrieval unit 33.

In step S89, the detailed information gazing detection unit 24 determines whether the user is operating based on the being-operated information received in step S88. The detailed information gazing detection unit 24 advances the processing to step S83 when determining that the user is operating (YES in step S89) and advances the processing to step S84 when determining that the user is not operating (NO in step S89).

As described above, according to the present exemplary embodiment, the information processing system 1 detects a gazing motion by a user at the detailed information by detecting an operation performed by the user on the detailed information display device 3

According to the above-described processing, the information processing system 1 can control display of the summary information on the display unit 125 which may be an obstacle to browsing of the detailed information and a related operation to be performed based on a natural motion by a user to perform an operation on the detailed information display device. Accordingly, the information processing system 1 can improve visibility of the detailed information.

According to the first to seventh exemplary embodiments, the summary information generation unit 23 transmits the generated summary information as it is to the detailed information retrieval unit 33. When a plurality of summary information pieces is transmitted, the detailed information retrieval unit 33 needs to select the summary information to be a target for retrieving the detailed information. Thus, according to an eighth exemplary embodiment, the information processing system 1 selects the summary information to be a target for retrieving the detailed information from a plurality of the summary information pieces.

A system configuration of the information processing system 1 according to the present exemplary embodiment is similar to that of the first exemplary embodiment. In addition, a hardware configuration of each component in the information processing system 1 is similar to that of the first exemplary embodiment.

According to the present exemplary embodiment, the information processing system 1 selects the summary information again when the selected summary information is not the one desired by the user.

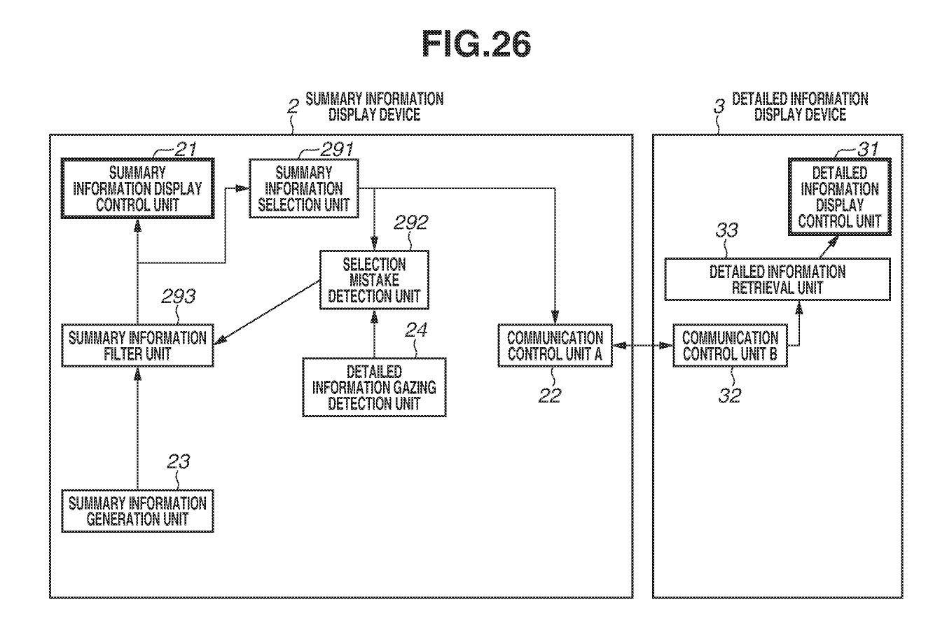

FIG. 26 illustrates an example of a functional configuration of each component in the information processing system 1 according to the present exemplary embodiment. The functional configuration in FIG. 26 differs from that in FIG. 6 in that the summary information display device 2 includes a summary information selection unit 291, a selection mistake detection unit 292, and a summary information filter unit 293. The selection mistake detection unit 292 is an example of a first detection unit.

Processing according to the present exemplary embodiment is described with reference to FIG. 26.

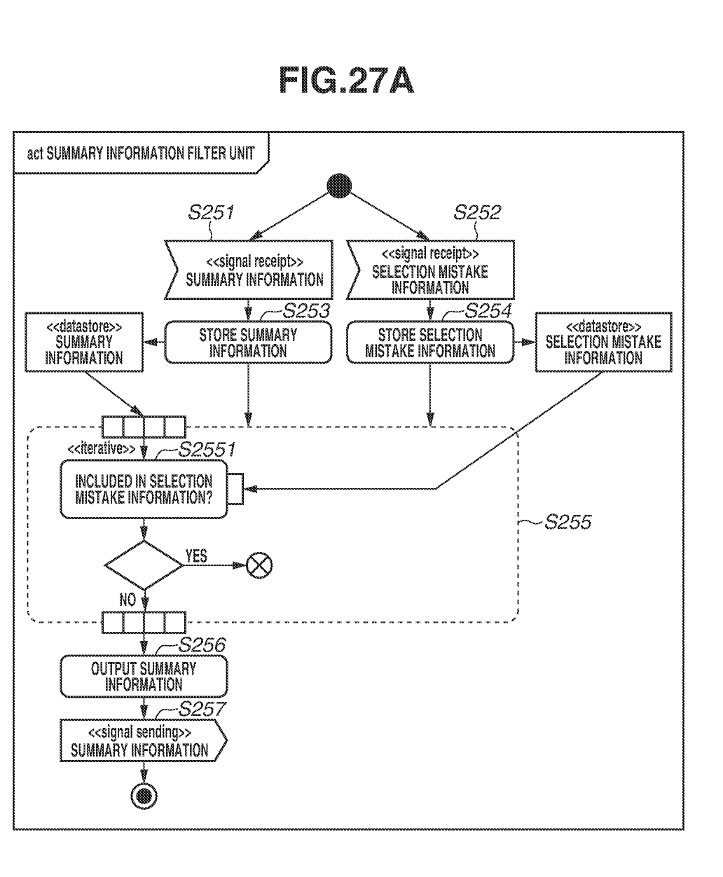

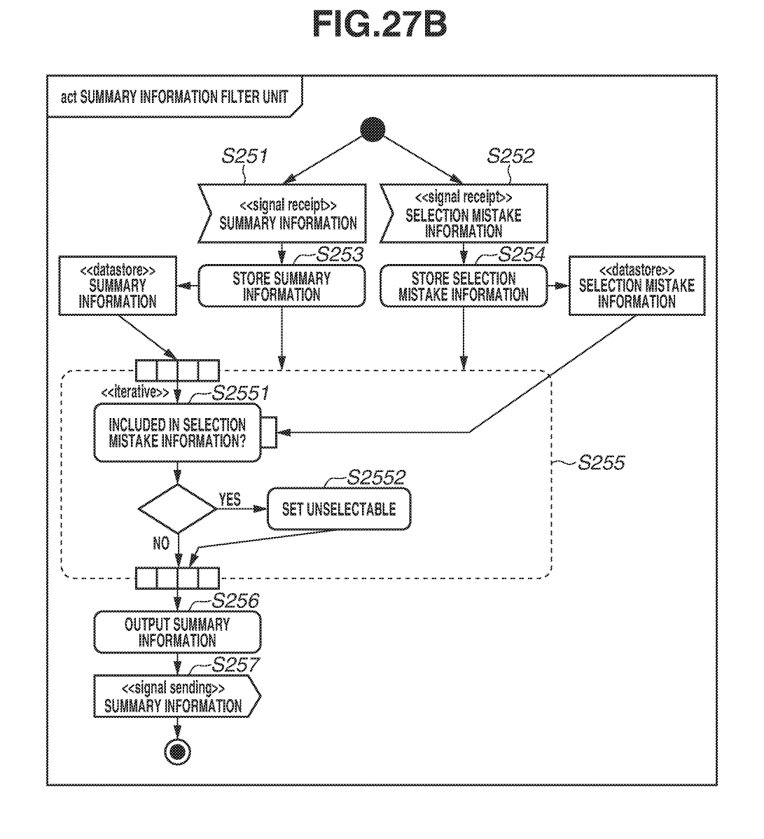

The summary information generation unit 23 transmits the generated summary information to the summary information display control unit 21 via the summary information filter unit 293. The summary information display control unit 21 displays the transmitted summary information on the display unit 125. The processing by the summary information filter unit 293 is described below with reference to FIGS. 27A and 27B.

The summary information filter unit 293 transmits the summary information to not only the summary information display control unit 21 but also the summary information selection unit 291. When a plurality of the summary information pieces is transmitted, the summary information selection unit 291 selects one of them. The summary information selected by the summary information selection unit 291 is an example of selection information.

The summary information selection unit 291 may select the summary information by an arbitrary method. The summary information selection unit 291 can select the summary information based on, for example, a designation by a user via a touch pad as the input unit 124 installed in a temple of an eyeglass type terminal device as the summary information display device 2 and voice recognition with respect to a voice uttered by a user via a microphone as the input unit 124. According to the present exemplary embodiment, one of the summary information is selected from the summary information pieces displayed on the display unit 125 based on a designation by a user via the input unit 124 in the summary information display device 2.

The summary information selection unit 291 transmits the selected summary information to the detailed information retrieval unit 33. The detailed information retrieval unit 33 retrieves the detailed information regarding the transmitted summary information. The detailed information display control unit 31 displays the detailed information retrieved by the detailed information retrieval unit 33 on the display unit 135.

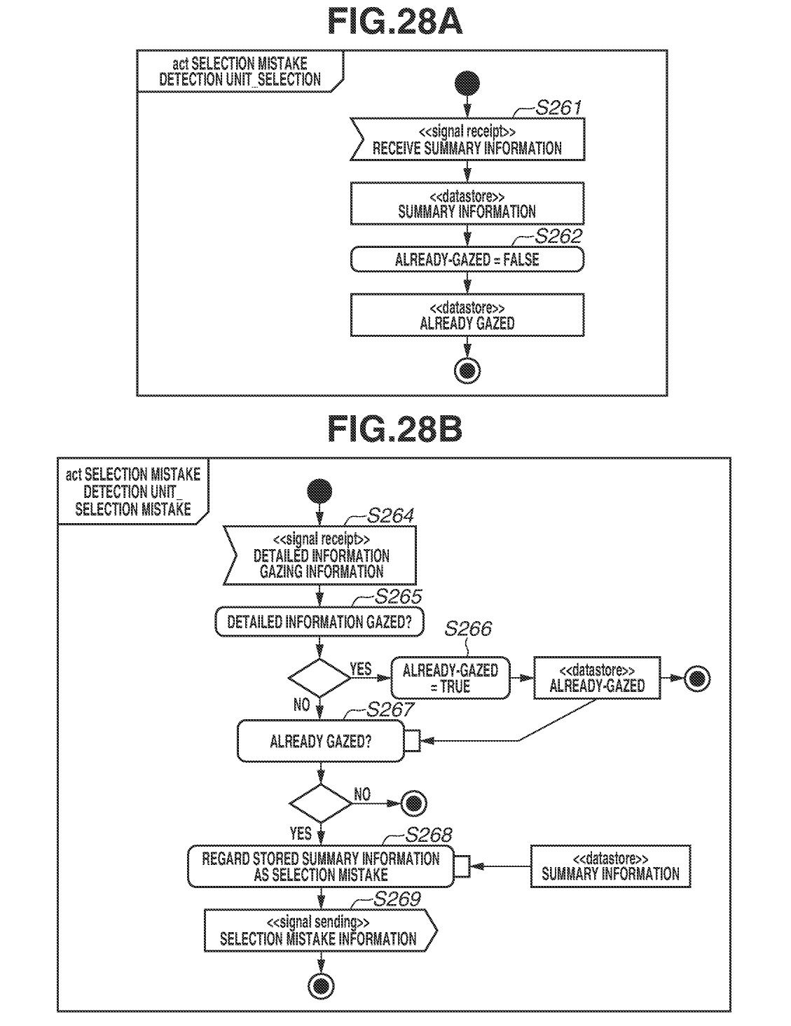

The summary information selection unit 291 transmits the selected summary information also to the selection mistake detection unit 292. The selection mistake detection unit 292 detects that the transmitted summary information is not the one desired by the user. When being able to detect that the transmitted summary information is not the one desired by the user, the selection mistake detection unit 292 transmits the summary information transmitted from the summary information selection unit 291 to the summary information filter unit 293 as selection mistake information indicating there is a selection mistake of the summary information. The processing by the selection mistake detection unit 292 is described below with reference to FIGS. 28A and 28B.

FIGS. 27A and 27B are activity diagrams illustrating an example of processing by the summary information filter unit 293. FIG. 27A illustrates processing for not displaying the summary information detected as the selection mistake on the display unit 125. FIG. 27B illustrates processing for displaying the summary information detected as the selection mistake on the display unit 125 and setting it unselectable.

First, the processing in FIG. 27A is described.

In step S251, the summary information filter unit 293 receives the summary information from the summary information generation unit 23.

In step S252, the summary information filter unit 293 receives the selection mistake information transmitted from the selection mistake detection unit 292.

In step S253, the summary information filter unit 293 stores the summary information received in step S251 in the main storage device 122, the auxiliary storage device 123, and the like.

In step S254, the summary information filter unit 293 stores the selection mistake information received in step S252 in the main storage device 122, the auxiliary storage device 123, and the like.

By the processing in steps S251 to S254, the summary information filter unit 293 can obtain the latest summary information and selection mistake information from the main storage device 122, the auxiliary storage device 123, and the like.

In step S255, the summary information filter unit 293 determines the summary information to be displayed on the display unit 125. The processing in step S255 is described in detail in following step S2551.

In step S2551, the summary information filter unit 293 determines whether each summary information stored in step S253 matches with the selection mistake information stored in step S254. When it is determined that the summary information included in the summary information pieces stored in step S253 matches with the selection mistake information stored in step S254 (YES in step S2551), the summary information filter unit 293 determines the relevant summary information as the summary information not to be displayed on the display unit 125. Whereas when it is determined that the summary information included in the summary information pieces stored in step S253 does not match with the selection mistake information stored in step S254 (NO in step S2551), the summary information filter unit 293 determines the relevant summary information as the summary information to be displayed on the display unit 125. The summary information filter unit 293 stores, for example, the summary information determined as the summary information to be displayed on the display unit 125 as a list in the main storage device 122, the auxiliary storage device 123, and the like. The summary information filter unit 293 performs the above-described processing on all of the summary information pieces stored in step S253 and, when completing the processing, advances the processing to step S256.

In step S256, the summary information filter unit 293 obtains the summary information determined in step S255 (step S2551) from the list stored in the main storage device 122, the auxiliary storage device 123, and the like.

In step S257, the summary information filter unit 293 transmits the summary information obtained in step S256 to the summary information display control unit 21.

In the processing in FIG. 27A, the summary information filter unit 293 stores one of the latest selection mistake information in step S254. However, the summary information filter unit 293 may store a plurality of the latest selection mistake information pieces in step S254. The summary information filter unit 293 may, for example, add new selection mistake information to the list including the already stored selection mistake information. Accordingly, the summary information once detected as the selection mistake is not displayed on the display unit 125 by the summary information display control unit 21 even if the new summary information is detected as the selection mistake.

The summary information filter unit 293 may continuously store only the set number of the latest selection mistake information pieces in the main storage device 122, the auxiliary storage device 123, and the like. Further, the summary information filter unit 293 may not store the selection mistake information of a set time elapsed from when being detected as the selection mistake.

Next, the processing in FIG. 27B is described. The processing in FIG. 27B differs from that in FIG. 27A in that the processing in step S255 includes processing in step S2552.

In step S2551, the summary information filter unit 293 determines whether each summary information stored in step S253 matches with the selection mistake information stored in step S254 as in the case in FIG. 27A. When determining as not matching with each other (NO in step S2551), the summary information filter unit 293 determines the relevant summary information as the summary information to be displayed on the display unit 125 as in the case in FIG. 27A. When determining as matching with each other (YES in step S2551), the summary information filter unit 293 advances the processing to step S2552.

In step S2552, the summary information filter unit 293 adds the summary information determined as matching with the selection mistake information stored in step S254 with unselectable information indicating that selection thereof by the summary information selection unit 291 is not permitted. For example, the summary information filter unit 293 stores the unselectable information in association with the summary information determined as matching with the selection mistake information in the main storage device 122, the auxiliary storage device 123, and the like.

The summary information selection unit 291 does not select the summary information added with the unselectable information.

Accordingly, the summary information detected as the selection mistake is displayed on the display unit 125 but is not selected again. The summary information display control unit 21 may display the summary information added with the unselectable information on the display unit 125 in a gray out state. Accordingly, a user can grasp that the relevant summary information is not selectable.

FIGS. 28A and 28B are activity diagrams illustrating an example of processing by the selection mistake detection unit 292.

When the detailed information regarding the summary information not desired is displayed on the display unit 135, it can be assumed that a user first gazes at the displayed detailed information, determines that a selection mistake of the summary information occurs, and lifts his/her gaze from the detailed information.

Thus, according to the present exemplary embodiment, when detecting a gazing motion by a user at the detailed information and then detecting that the user is not gazing at the detailed information, the information processing system 1 determines that the summary information selection unit 291 causes the selection mistake of the summary information.

FIG. 28A illustrates an example of processing by the selection mistake detection unit 292 when new summary information is selected by the summary information selection unit 291.

In step S261, the selection mistake detection unit 292 receives the summary information selected by the summary information selection unit 291 from the summary information selection unit 291 and stores the received summary information in the main storage device 122, the auxiliary storage device 123, and the like.

In step S262, the selection mistake detection unit 292 sets an already-gazed flag to False. The already-gazed flag is information indicating whether a user gases at the detailed information and is stored in the main storage device 122, the auxiliary storage device 123, and the like. The selection mistake detection unit 292 sets a value of the already-gazed flag to False while the detailed information corresponding to the selected summary information has never been gazed by a user. When the detailed information corresponding to the selected summary information is once gazed by a user, the selection mistake detection unit 292 sets the value of the already-gazed flag to True. In step S262, the summary information is newly selected, and thus the selection mistake detection unit 292 sets the already-gazed flag to False.

Next, an example of the processing by the selection mistake detection unit 292 when the detailed information gazing information is received from the detailed information gazing detection unit 24 is described with reference to FIG. 28B.

In step S264, the selection mistake detection unit 292 receives the detailed information gazing information from the detailed information gazing detection unit 24.

In step S265, the selection mistake detection unit 292 determines whether a user is gazing at the detailed information displayed on the display unit 135 based on the detailed information gazing information received in step S264. When determining that the user is gazing at the detailed information displayed on the display unit 135 (YES in step S265), the selection mistake detection unit 292 advances the processing to step S266. Whereas when determining that the user is not gazing at the detailed information displayed on the display unit 135 (NO in step S265), the selection mistake detection unit 292 advances the processing to step S267.

In step S266, the selection mistake detection unit 292 sets the already-gazed flag to True. By the processing in step S266, the already-gazed flag is set to True if a user once gazes at the detailed information.

In step S267, the selection mistake detection unit 292 determines whether the already-gazed flag is True or False. When determining that the already-gazed flag is False (NO in step S267), the selection mistake detection unit 292 terminates the processing in FIG. 28B since the user has never gazed at the detailed information even once. Whereas when determining that the already-gazed flag is True (YES in step S267), the selection mistake detection unit 292 advances the processing to step S268.

In step S268, the selection mistake detection unit 292 detects the selection mistake of the summary information by the summary information selection unit 291 since the user lifts his/her gaze after gazing at the detailed information.

In step S269, the selection mistake detection unit 292 transmits the summary information detected as the selection mistake in step S268 to the summary information filter unit 293 as the selection mistake information.

As described above, according to the processing in the present exemplary embodiment, when the selection mistake of the summary information occurs, the information processing system 1 can avoid selecting the same summary information again based on a natural operation by a user to gaze at the detailed information and then to lift his/her gaze therefrom. Accordingly, the information processing system 1 can avoid selecting the same summary information again when the selection mistake of the summary information occurs. According to the present exemplary embodiment, the selection mistake detection unit 292 determines whether selection of the summary information is a mistake based on the detailed information gazing information from the detailed information gazing detection unit 24, however, may determine based on other information. For example, in the case that a display system includes the face recognition unit 351, and the face recognition unit 351 estimates a line of sight of a user, the selection mistake detection unit 292 may perform machine learning on a movement of a line of sight in the case of “selection mistake” and determines whether it is a selection mistake based on the learning result.

According to the present exemplary embodiment, the selection mistake detection unit 292 determines that the selection mistake of the summary information occurs when a user gazes at the detailed information and then lifts his/her gaze from the detailed information. However, it can be assumed that even when the detailed information of the desired summary information is displayed on the display unit 135, a user lifts his/her gaze from the detailed information after thoroughly browsing the detailed information. Thus, the selection mistake detection unit 292 may determine that the selection mistake of the summary information occurs when a user lifts his/her gaze from the detailed information within a set period (e.g., three seconds) after gazing at the detailed information.

According to the eighth exemplary embodiment, when a selection mistake of the summary information is detected, the information processing system 1 selects the summary information again based on a designation by a user via the input unit 124. According to a ninth exemplary embodiment, the information processing system 1 selects the summary information again without an operation by a user.

A system configuration of the information processing system 1 according to the present exemplary embodiment is similar to that of the first exemplary embodiment. In addition, a hardware configuration of each component in the information processing system 1 is similar to that of the first exemplary embodiment.

There are following cases that a user makes a mistake in selecting the summary information.

(1) A case when mistakenly selecting the summary information displayed on a position physically near to the desired summary information on the display unit 125.
(2) A case when mistakenly selecting the summary information in a similar category.
(3) A case when intending to find target detailed information by skimming through the detailed information pieces in similar categories.

Regarding such cases, the processing by the information processing system 1 according to the present exemplary embodiment is described.

A user behavior immediately before the user determines as the selection mistake of the summary information is “gazing at the detailed information”. It can be assumed that the user determines as the selection mistake of the summary information after viewing the detailed information displayed on the display unit 135.

In addition, the information processing system 1 according to the present exemplary embodiment detects the selection mistake of the summary information and selects other summary information without depending on a user operation. It is assumed that a user who gazes at the detailed information regarding the mistakenly selected summary information once lifts his/her gaze therefrom and then gazes again at the display unit 135 in expectation of new detailed information.

Thus, when “gazing, not gazing, and gazing” by a user at the detailed information is detected within a set period, the information processing system 1 according to the present exemplary embodiment determines that the summary information selected by the summary information selection unit 291 is the selection mistake.

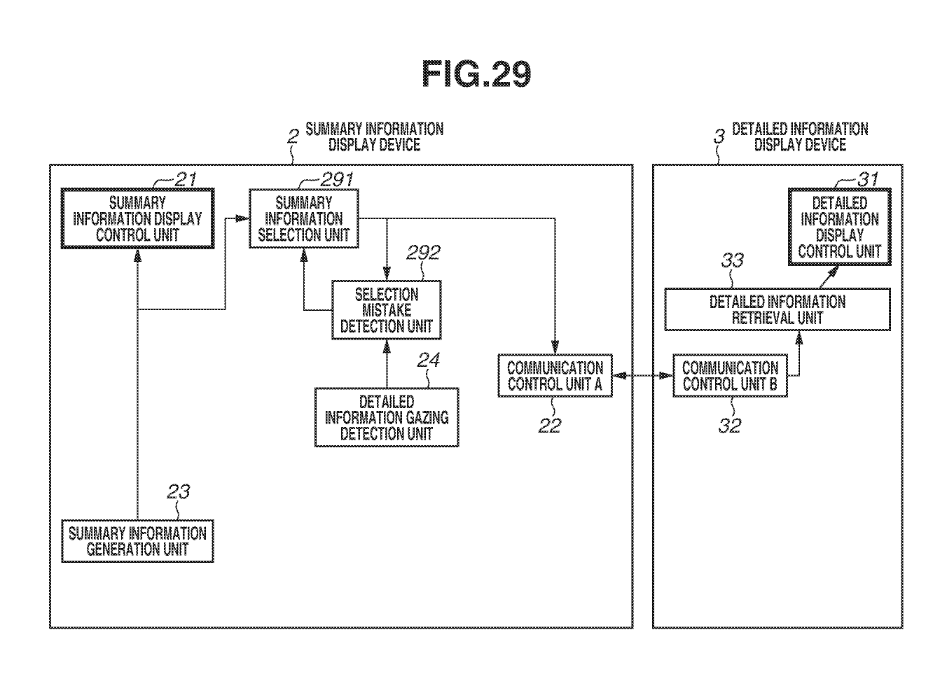

FIG. 29 illustrates an example of a functional configuration of each component in the information processing system 1 according to the present exemplary embodiment. The functional configuration in FIG. 29 differs from that in FIG. 26 in that the summary information display device 2 does not include the summary information filter unit 293. Further, the summary information selection unit 291 and the selection mistake detection unit 292 according to the present exemplary embodiment perform different processing from that in the eighth exemplary embodiment.

The processing in the present exemplary embodiment differs from that in the eighth exemplary embodiment in following points.

FIG. 30 is a state machine diagram illustrating an example of the processing by the selection mistake detection unit 292.

In step S281, the selection mistake detection unit 292 is in a not-gazing state indicating that a user is not gazing at the detailed information. When the summary information selected by the summary information selection unit 291 is received from the summary information selection unit 291, the selection mistake detection unit 292 stores the received summary information in the main storage device 122, the auxiliary storage device 123, and the like. When the detailed information gazing information is received from the detailed information gazing detection unit 24, and the received detailed information gazing information indicates that the user is gazing at the detailed information, the selection mistake detection unit 292 advances the processing to step S282. When the detailed information gazing information is received from the detailed information gazing detection unit 24, and the received detailed information gazing information indicates that the user is not gazing at the detailed information, the selection mistake detection unit 292 remains in the not-gazing state.

In step S282, the selection mistake detection unit 292 is in a gazing state indicating that the user is gazing at the detailed information. When the detailed information gazing information is received from the detailed information gazing detection unit 24, and the received detailed information gazing information indicates that the user is not gazing at the detailed information, the selection mistake detection unit 292 advances the processing to step S283. When the received detailed information gazing information indicates that the user is gazing at the detailed information, the selection mistake detection unit 292 remains in the gazing state. Further, when the summary information is received from the summary information selection unit 291, the selection mistake detection unit 292 stores the received summary information in the main storage device 122, the auxiliary storage device 123, and the like and remains in the gazing state.

In step S283, the selection mistake detection unit 292 is in a not-gazing (time measurement) state in which the user is not gazing at the detailed information, and an elapsed time is measured. When the selection mistake detection unit 292 is in the not-gazing (time measurement) state, the elapsed time is measured via a timer in the summary information display device 2 and the like. The selection mistake detection unit 292 measures the time to determine whether transition of “gazing, not gazing, and gazing” by the user at the detailed information occurs within the set time period. The selection mistake detection unit 292 stores a time when the state is shifted to the not-gazing (time measurement) state in the main storage device 122, the auxiliary storage device 123, and the like. Further, the selection mistake detection unit 292 obtains a not-gazing time indicating a time length in which the user is not gazing at the detailed information from a difference between a time when the state is shifted from the not-gazing (time measurement) state to another state and the stored time.

The selection mistake detection unit 292 receives the detailed information gazing information from the detailed information gazing detection unit 24 in the not-gazing (time measurement) state and performs following processing when the received detailed information gazing information indicates that the user is gazing at the detailed information. In other words, the selection mistake detection unit 292 obtains the not-gazing time and determines whether the obtained not-gazing time is less than a set threshold value.

When the obtained not-gazing time is less than the set threshold value, it means that the transition of “gazing, not gazing, and gazing” by the user at the detailed information occurs within the set time period, so that the selection mistake detection unit 292 determines that the summary information selected by the summary information selection unit 291 is the selection mistake. Subsequently, the selection mistake detection unit 292 transmits the summary information determined as the selection mistake to the summary information selection unit 291 as the selection mistake information. The selection mistake detection unit 292 advances the processing to step S282 and shifts to the gazing state again when the obtained not-gazing time is less than the set threshold value or when the obtained not-gazing time is greater than or equal to the set threshold value.

In the case that the detailed information gazing information is received from the detailed information gazing detection unit 24 after shifting to the not-gazing (time measurement) state in step S283, and the received detailed information gazing information indicates not-gazing, the selection mistake detection unit 292 remains in the not-gazing (time measurement) state.

When the summary information is received from the summary information selection unit 291 after shifting to the not-gazing (time measurement) state in step S283, the selection mistake detection unit 292 stores the received summary information in the main storage device 122, the auxiliary storage device 123, and the like, advances the processing to step S281, and shifts to the not-gazing state.

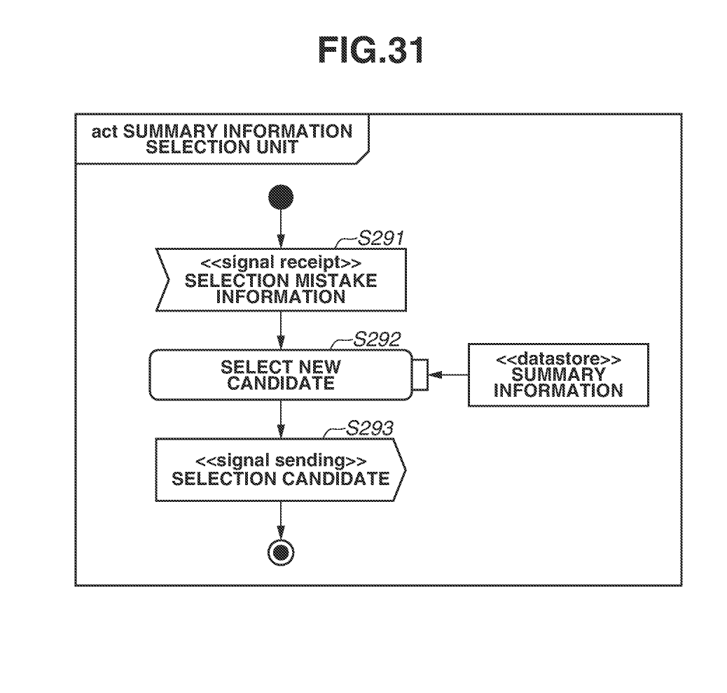

FIG. 31 is an activity diagram illustrating an example of processing by the summary information selection unit 291 according to the present exemplary embodiment. The summary information selection unit 291 may select the summary information based on a designation by a user via the input unit 124 as in the case in the eighth exemplary embodiment in addition to the processing in FIG. 31.

First, when receiving the summary information from the summary information generation unit 23, the summary information selection unit 291 stores the received summary information in the main storage device 122, the auxiliary storage device 123, and the like.

In step S291, the summary information selection unit 291 receives the selection mistake information from the selection mistake detection unit 292.

In step S292, the summary information selection unit 291 selects one from the summary information pieces stored in the main storage device 122, the auxiliary storage device 123, and the like.

In step S293, the summary information selection unit 291 transmits the summary information selected in step S292 to the selection mistake detection unit 292 and the detailed information retrieval unit 33.

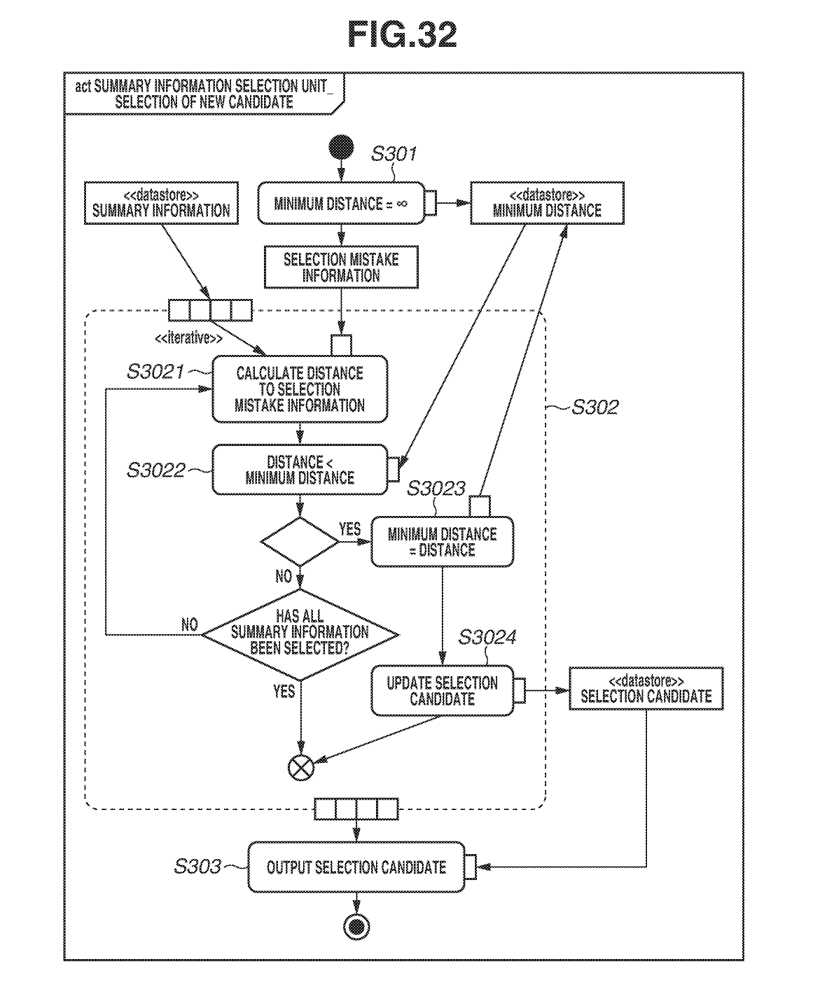

FIG. 32 is an activity diagram illustrating an example of processing by the summary information selection unit 291. The processing in step S292 is described in detail with reference to FIG. 32.

The summary information selection unit 291 prepares, for example, a variable “minimum distance” on the main storage device 122. The “minimum distance” is a variable storing a minimum one in distances between the summary information indicated by the selection mistake information transmitted from the selection mistake detection unit 292 to the summary information selection unit 291 and the respective summary information pieces as selection candidates by the summary information selection unit 291 The distance is an index for indicating a degree of deviation between the summary information indicated by the selection mistake information and each of the summary information pieces. The distance here may indicate a deviation in a physical distance such as a Euclidean distance or a deviation in meaning.

In step S301, the summary information selection unit 291 sets a value of “minimum distance” to ∞ (an infinite).

In step S302, the summary information selection unit 291 calculates distances between the respective summary information pieces and the selection mistake information and determines the summary information having a minimum distance as a selection candidate. The processing in step S302 is described in detail in following steps S3021 to S3024.

In step S3021, the summary information selection unit 291 selects one of the summary information pieces stored in the main storage device 122, the auxiliary storage device 123, and the like and obtains a distance between the selected summary information and the summary information indicated by the selection mistake information. In the case of the above-described case (1), the summary information selection unit 291 obtains, for example, a Euclidean distance between display positions on the display unit 125 of the summary information pieces as annotations.

In the cases of the above-described cases (2) and (3), the summary information selection unit 291 obtains a distance between categories defined separately. According to the present exemplary embodiment, the summary information generated by the summary information generation unit 23 is attached with category information. The category information is information indicating which category the summary information belongs to and includes “bridge”, “building”, “restaurant”, “station”, and the like. The summary information may be attached with a plurality of category information pieces. In such a case, the summary information selection unit 291 can obtain a distance using arbitrary category information. For example, the summary information selection unit 291 may calculate distances of combinations of all categories and determine the minimum one as a final result.

In step S3022, the summary information selection unit 291 determines whether the distance obtained in step S3021 is less than the “minimum distance”. When determining that the distance obtained in step S3021 is less than the “minimum distance”, the summary information selection unit 291 advances the processing to step S3023. When it is determined that the distance obtained in step S3021 is greater than or equal to “minimum distance”, and all of the summary information pieces stored in the main storage device 122, the auxiliary storage device 123, and the like are already selected in step S3021, the summary information selection unit 291 advances the processing to step S303. Whereas when it is determined that the distance obtained in step S3021 is greater than or equal to “minimum distance”, and all of the summary information pieces stored in the main storage device 122, the auxiliary storage device 123, and the like are not yet selected in step S3021, the summary information selection unit 291 advances the processing to step S3021.

In step S3023, the summary information selection unit 291 updates the value of the “minimum distance” with the distance obtained in step S3021.

In step S3024, the summary information selection unit 291 sets the summary information selected in step S3021 as the selection candidate.

As described above, the summary information selection unit 291 can set the summary information having the minimum distance to the summary information indicated by the selection mistake information to the selection candidate by the processing in step S302.

In step S303, the summary information selection unit 291 outputs the summary information of the selection candidate determined in step S302 as a processing result of step S292.

According to the functional configuration in FIG. 29, the summary information once determined as the selection mistake may be selected by the summary information selection unit 291 in the case of second selection mistake. Thus, the summary information display device 2 may include the summary information filter unit 293 as in the case in the eighth exemplary embodiment. Accordingly, the information processing system 1 can avoid reselecting the summary information once determined as the selection mistake.

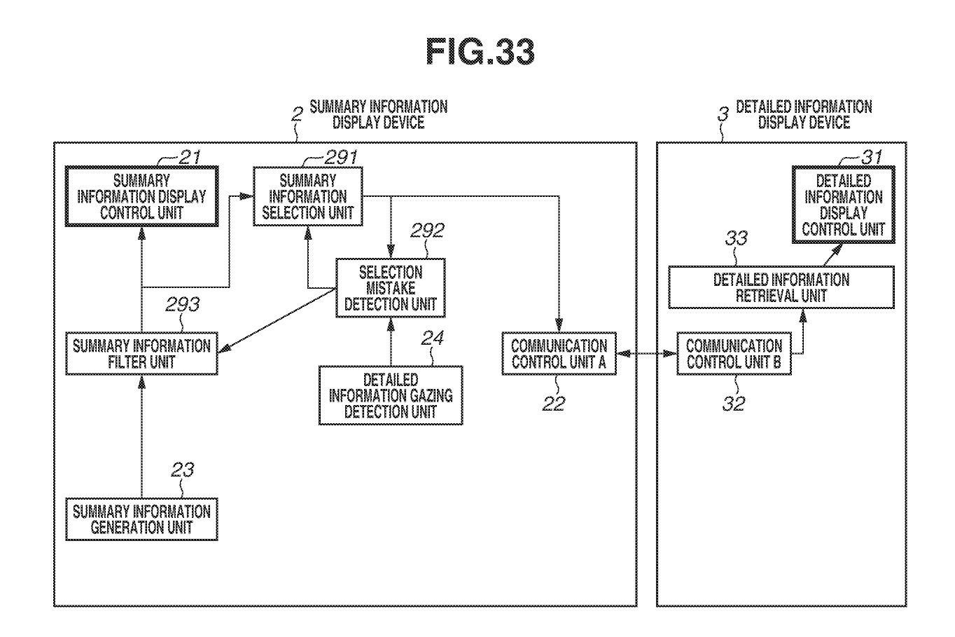

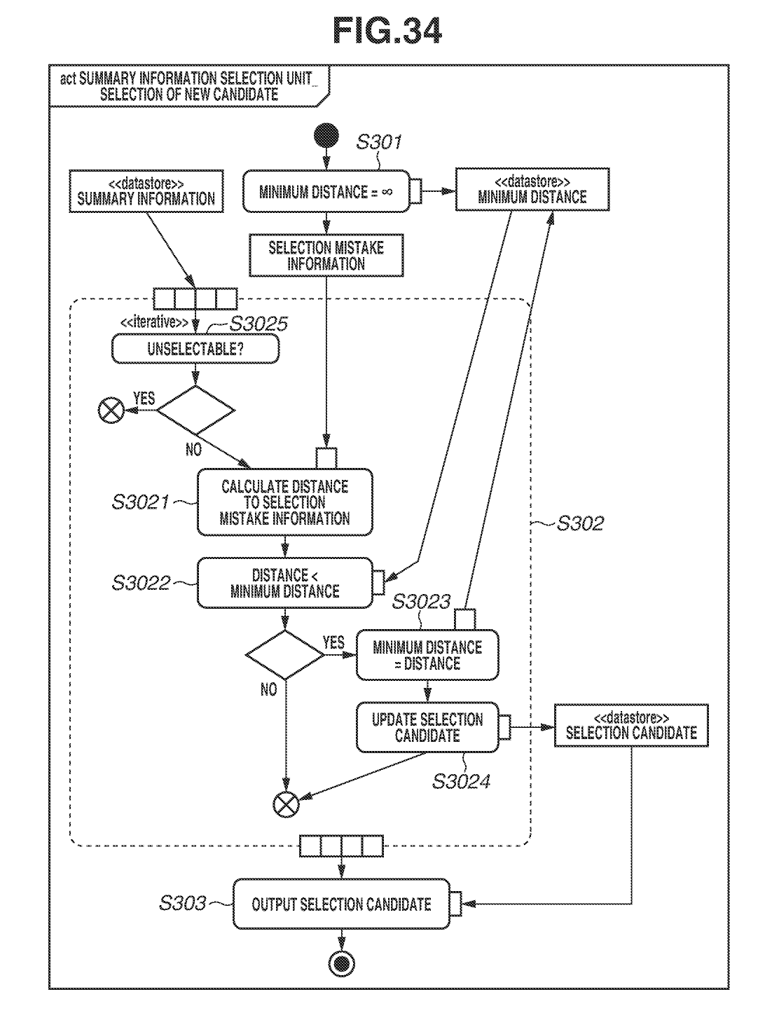

FIG. 33 illustrates an example of the functional configuration of each component in the information processing system 1 in this case. The processing by the summary information filter unit 293 is similar to that according to the eighth exemplary embodiment. The processing in step S292 when the summary information filter unit 293 performs the processing in FIG. 27B is described in detail with reference to FIG. 34.

FIG. 34 is an activity diagram illustrating an example of the processing by the summary information selection unit 291. The processing in FIG. 34 differs from that in FIG. 32 in that processing in step S3025 is included.

In step S3025, the summary information selection unit 291 determines whether to set each of the summary information pieces stored in the main storage device 122, the auxiliary storage device 123, and the like unselectable based on whether the unselectable information is attached thereto. In step S3021, the summary information selection unit 291 selects one from the summary information pieces excluding the summary information determined to be set unselectable in step S3025.

As described above, according to the processing in the present exemplary embodiment, the information processing system 1 can automatically select new summary information based on a natural operation by a user to be “gazing, not gazing, and gazing” at the detailed information when making a mistake in selection of the summary information. Accordingly, the information processing system 1 can more easily select the summary information.

According to the present exemplary embodiment, the selection mistake detection unit 292 determines whether the selection of the summary information is a mistake based on the detailed information gazing information from the detailed information gazing detection unit, however, may determine based on other information.

For example, when the information processing system 1 includes the face recognition unit 351, a line of sight of a user is estimated via the face recognition unit 351, and the selection mistake detection unit 292 may detect the selection mistake of the summary information based on the estimated line of sight of the user. The selection mistake detection unit 292 may determine whether the summary information is the selection mistake based on, for example, a line-of-sight model of a user in the case that the detailed information regarding the summary information preliminarily learned as the selection mistake is displayed on the display unit 135.

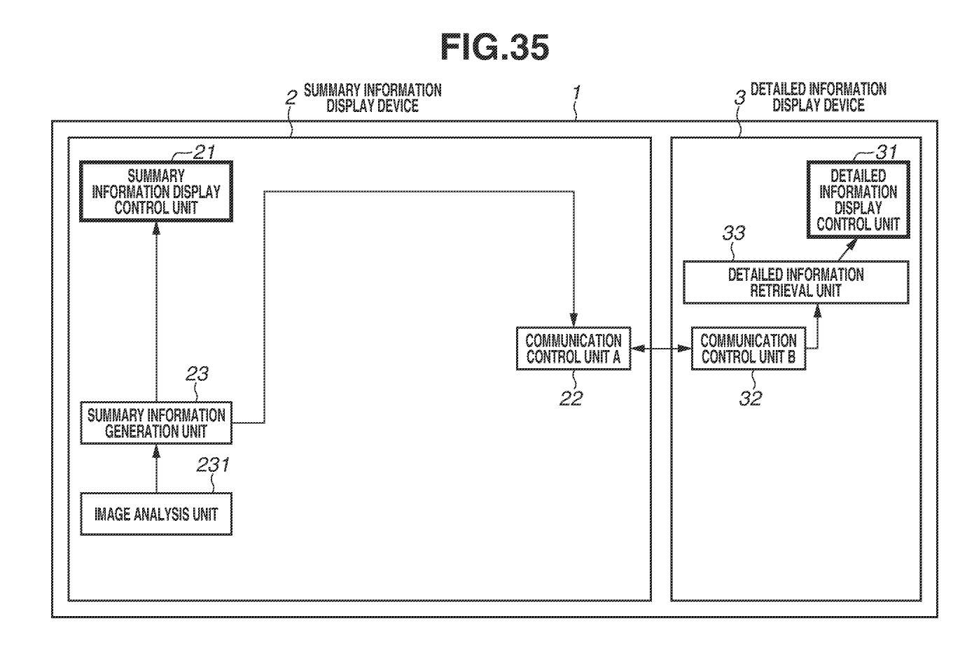

According to the first exemplary embodiment, the summary information generation unit 23 generates the summary information to be presented to a user based on a visual recognition target of a user such as an image displayed on the display unit 125 and an actual landscape. According to a tenth exemplary embodiment, the summary information to be presented to a user is generated based on information related to the above-described visual recognition target of the user. A system configuration of the information processing system 1 according to the present exemplary embodiment is similar to that of the first exemplary embodiment. In addition, a hardware configuration of each component in the information processing system 1 is similar to that of the first exemplary embodiment. FIG. 35 illustrates an example of a functional configuration of the information processing system 1 according to the present exemplary embodiment. The functional configuration in FIG. 35 differs from that in FIG. 3 in that an image analysis unit 231 is further added thereto. Processing according to the present exemplary embodiment is described in detail below, however, the processing is almost similar to that of the first exemplary embodiment, and thus differences from the first exemplary embodiment are mainly described.

The summary information display device 2 is a computer and a display monitor connected to the computer, and the image analysis unit 231 processes and displays a video captured by the image capturing unit 126.

The image capturing unit 126 is, for example, a monitoring camera, and one or a plurality of image capturing units is installed. The image analysis unit 231 analyzes a video captured by the image capturing unit 126 and specifies a person included in the video. Further, the image analysis unit 231 outputs the video and the analysis result. The image analysis unit 231 may have a recording and reproducing function. In this case, the image analysis unit 231 can output a past video and an analysis result of a person included in the past video.

According to the present exemplary embodiment, a monitoring camera is described as an example of the image capturing unit 126, however, the present exemplary embodiment is not limited to the monitoring camera and may be applied to any image capturing device such as a camera installed in an assembly line in a factory, a camera installed in an industrial robot, a medical image capturing apparatus such as an X-ray image capturing apparatus, an astronomical telescope with an image capturing device, and a television microscope.

Further, according to the present exemplary embodiment, the image analysis unit 231 is described using an example when a person captured in a video is identified, however, the present exemplary embodiment is not limited to this example and may identify an object corresponding to a purpose such as an assembly part, a focus of disease, a celestial body, and a microorganism. Identification described here may be to identify individual according to a purpose and to classify an object into a category such as a microorganism name.

When a plurality of the image capturing units 126 is connected to the image analysis unit 231, the image analysis unit 231 may output a video from any one of the image capturing units 126 or output videos from the plurality of the image capturing units 126 by arranging, for example, in a tile format. In addition, the image analysis unit 231 may be installed outside the summary information display device 2, and in this case, communication with each component in the summary information display device 2 is performed via the communication control unit A 22.

A video captured by the image capturing unit 126 is transmitted to the image analysis unit 231. The image analysis unit 231 receives and analyzes the video captured by the image capturing unit 126 and identifies a person included in the image as an analysis result. The identified result is stored as a personal ID, and information regarding the relevant person can be retrieved by referring to a database (not illustrated). A content in the above-described database is updated with the analysis result of the image analysis unit 231 as needed.

The image analysis unit 231 outputs a video of any one of the image capturing units 126 and a personal ID included in the video together with information in a related screen. The information in the related screen may include coordinates of a head of the relevant person, diagonal coordinates of a bounding box surrounding the whole person, and a mask image and its coordinates of a person area and be used when the summary information display control unit 21 displays the summary information by superimposing on the video.

The output from the image analysis unit 231 is transmitted to the summary information generation unit 23. The summary information generation unit 23 generates the summary information to be presented to a user based on the information in the related screen received from the image analysis unit 231. The summary information generated by the summary information generation unit 23 is an object such as a drawing and a character string to be displayed near a person. The object includes a personal ID, a person name obtained by retrieving a database (not illustrated) based on the personal ID, a mark displayed near a head of the relevant person, a bounding box surrounding the whole person, a semi-transparent mask image indicating the person area, and the like. The person name may be included in the output of the image analysis unit 231. According to the present invention, the object is not limited to the above-described one, and a plurality of objects may be used.

The summary information display control unit 21 displays the video obtained from the image analysis unit 231 on the display unit 125 by superimposing the summary information generated by the summary information generation unit 23 thereon. The video may be obtained from the image capturing unit 126 as long as the image analysis unit 231 does not process the video.

The summary information generation unit 23 transmits the generated summary information to the detailed information retrieval unit 33 in the detailed information display device 3 via the communication control unit A 22 and the communication control unit B 32. The summary information to be transmitted to the detailed information retrieval unit 33 is not necessarily all of the generated information pieces, and may be, for example, only the personal ID received from the image analysis unit 231.

On the other hand, the detailed information retrieval unit 33 retrieves the detailed information regarding the received summary information based on the summary information received from the summary information generation unit 23. For example, the detailed information retrieval unit 33 retrieves the detailed information related to the person such as a name, an address, and a detected history in the past of the person by referring to a database (not illustrated) based on the received personal ID.

As described above, according to the present exemplary embodiment, the summary information display device 2 generates the summary information to be presented to a user based on information related to a visual recognition target of the user.

According to the present exemplary embodiment, the image capturing unit 126 and the image analysis unit 231 are included in the summary information display device 2. However, the present exemplary embodiment is not limited to this configuration, and a part or all of the image capturing unit 126 and the image analysis unit 231 may be configured as devices different from the summary information display device 2.

According to the eighth exemplary embodiment, the summary information is selected based on a designation by a user via a touch pad as the input unit 124 installed in a temple of an eyeglass type terminal device as the summary information display device 2 and voice recognition with respect to a voice uttered by a user via a microphone as the input unit 124. According to an eleventh exemplary embodiment, an example is described in which a touch panel integrated with the display unit 125, a pointing device such as a touch pen and a mouse, and a keyboard are used as the input unit 124.

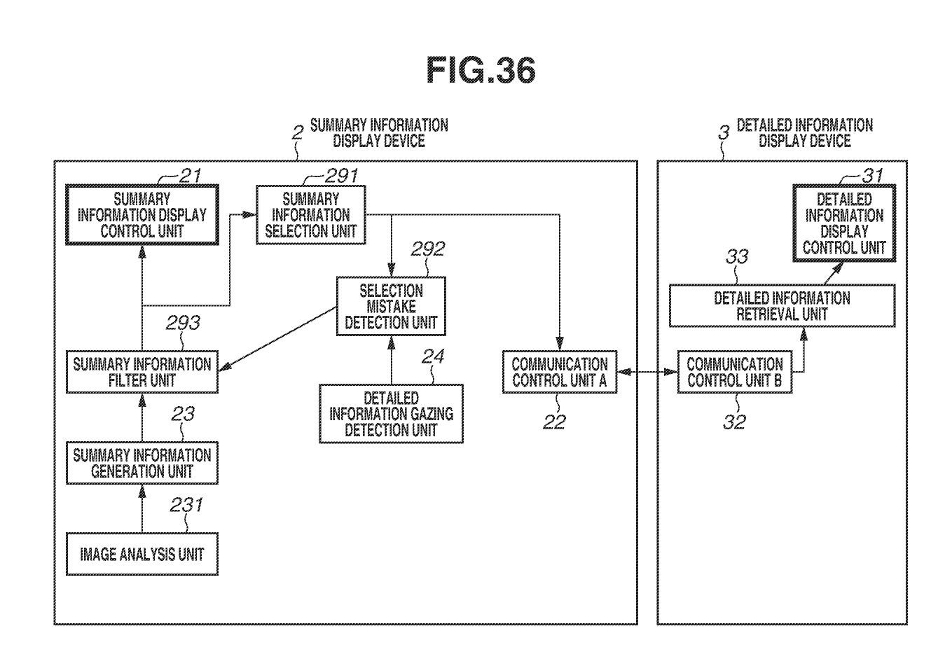

A system configuration of the information processing system 1 according to the present exemplary embodiment is similar to that of the first exemplary embodiment. In addition, a hardware configuration of each component in the information processing system 1 is similar to that of the first exemplary embodiment. FIG. 36 illustrates an example of a functional configuration of the information processing system 1 according to the present exemplary embodiment. The functional configuration in FIG. 36 differs from that in FIG. 26 in that an image analysis unit 231 is further added thereto. Processing according to the present exemplary embodiment is described in detail below, however, the processing is almost similar to that of the eighth and the tenth exemplary embodiments, and thus differences from these exemplary embodiments are mainly described.

The summary information display control unit 21 superimposingly displays one or a plurality of the summary information pieces on the display unit 125. The summary information selection unit 291 selects one of the summary information from these summary information pieces based on a designation by a user via the input unit 124.

When the input unit 124 is a keyboard, a selection candidate of the summary information is displayed in sequence by using, for example, a “space” key and an arrow key, and when a selection candidate of the desired summary information is displayed, for example, an “enter” key is pressed to select one of the summary information. Alternatively, the summary information may be selected by the “space” key and the arrow key in turns without requiring an input by the “enter” key. A case is described below in which the input unit 124 is not a keyboard but a touch panel integrated with the display unit 125 and a pointing device such as a touch pen and a mouse.

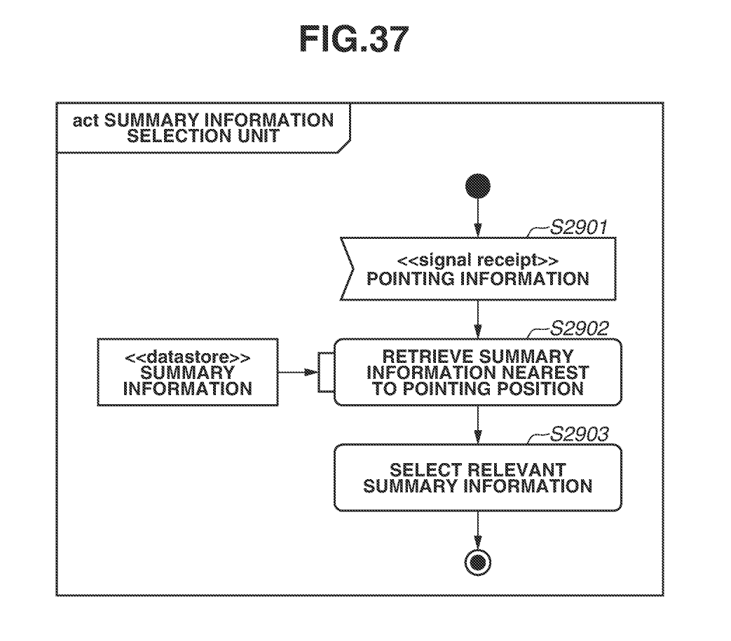

FIG. 37 illustrates operations of the summary information selection unit 291. In step S2901, the summary information selection unit 291 obtains pointing information from the pointing device of the input unit 124. The pointing information is a position (a pointing position) in the display unit 125 pointed by the input unit 124. Next, in step S2902, the summary information selection unit 291 retrieves the summary information nearest to the pointing position. Then, in step S2903, the summary information selection unit 291 selects the relevant summary information.

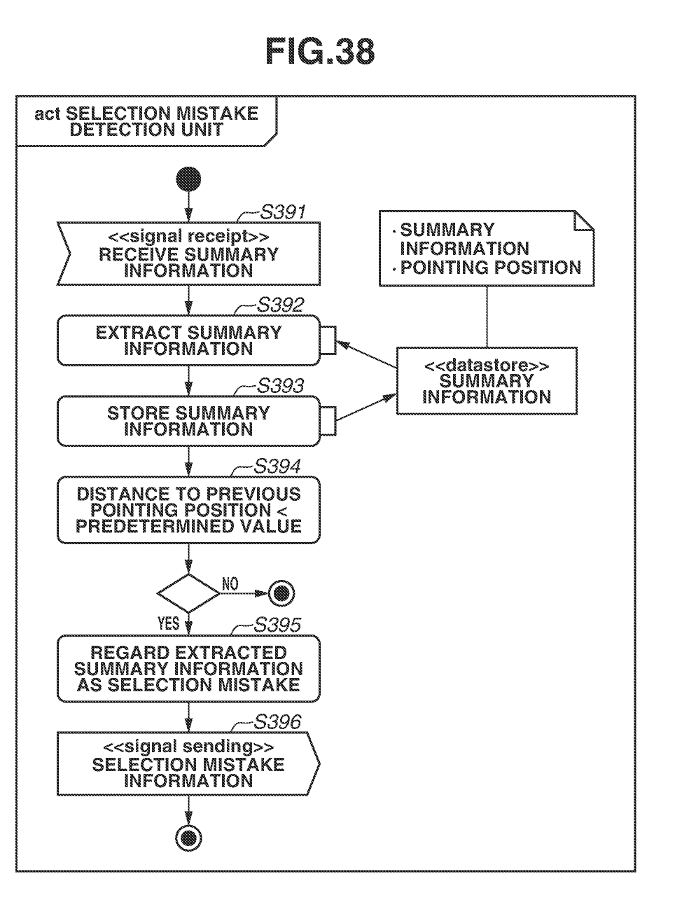

When the input unit 124 performs pointing again, the selection mistake detection unit 292 determines that a selection mistake occurs prior to selection. FIG. 38 corresponds to FIGS. 28A and 28B and is an activity diagram illustrating an example of processing by the selection mistake detection unit 292. In step S391, when receiving the summary information, in step S392, the selection mistake detection unit 292 extracts the summary information stored in a previous time. The summary information includes the pointing information when the summary information is selected. The pointing information of the stored summary information is initialized in advance to a position which is a predetermined value away from any positions that the pointing information can take. In step S393, the selection mistake detection unit 292 stores the received summary information.

In step S394, the selection mistake detection unit 292 determines whether a distance between the pointing information of the extracted summary information and the pointing position of the received summary information is less than the above-described predetermined value. When the distance is greater than or equal to the predetermined value (NO in step S394), the selection mistake detection unit 292 terminates the processing without doing anything. When the distance is less than the predetermined value (YES in step S394), in step S395, the selection mistake detection unit 292 regards the extracted summary information as the selection mistake, and, in step S396, transmits the selection mistake information.

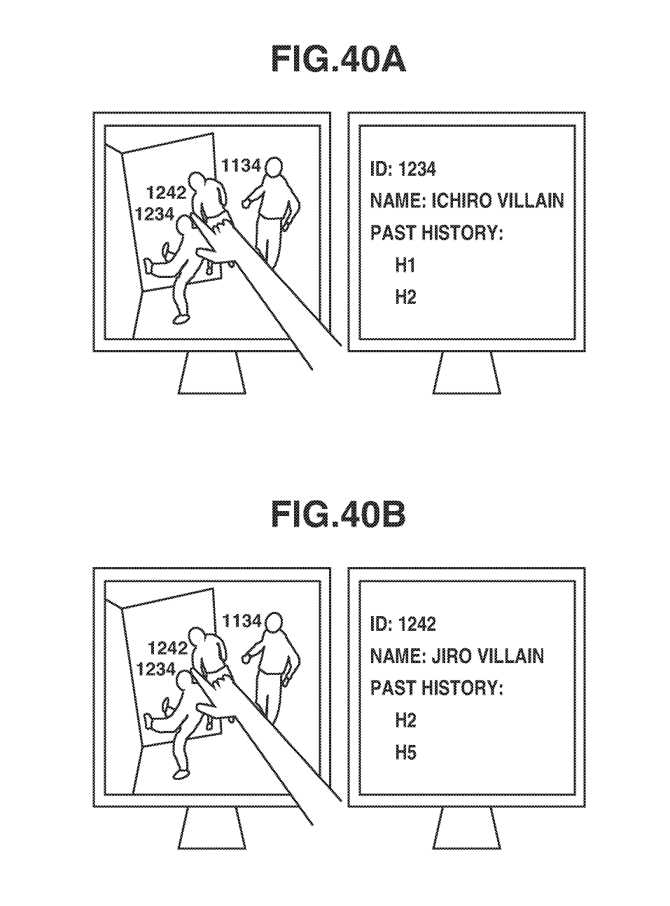

FIGS. 40A and 40B illustrate outlines of processing by the selection mistake detection unit 292 according to the present exemplary embodiment. In FIG. 40A, three persons having personal IDs 1134, 1234, and 1242 are displayed on a left display (the display unit 125). When one point on a left on the display unit 125 is pointed, detailed information pieces related to a person nearest to the pointing position such as a name, an address, and a detected history in the past are displayed on a right display (the display unit 135).

Subsequently, as illustrated in FIG. 40B, when one point on the left display (the display unit 125) is pointed again, in step S391, the selection mistake detection unit 292 receives the summary information of a person nearest to the pointing position and, in step S392, extracts the summary information stored in the previous time. In step S394, the selection mistake detection unit 292 determines whether a distance between the pointing information of the extracted summary information and the pointing position of the received summary information is less than the above-described predetermined value. Here, the selection mistake detection unit 292 determines that the distance is less than the predetermined value and, in step S395, regards the extracted summary information as the selection mistake. Then, in step S396, the selection mistake detection unit 292 transmits the selection mistake information. In FIG. 40B, the selection mistake detection unit 292 determines that the selection mistake occurs, and thus the detailed information of a person next nearest to the pointing position is displayed on the right display (the display unit 135).

Accordingly, the pointing device can be used for selecting the summary information, and the desired summary information can be selected in a short time.

In the case that the selected summary information is not the desired summary information, if selection may be performed in the proximity of the relevant summary information, the summary information nearest to the selected position is selected from the other summary information pieces excluding the relevant summary information, and thus the desired summary information can be selected in a short time.

According to the eleventh exemplary embodiment, the summary information nearest to the selected position is regarded as a candidate. However, the summary information distant from the selected position is not excluded from the candidate. Thus, when reselection is mistakenly performed, the summary information distant from the selected position is selected. Therefore, according to a twelfth exemplary embodiment, the summary information at a position obviously distant from the selected position is excluded from a selection target.

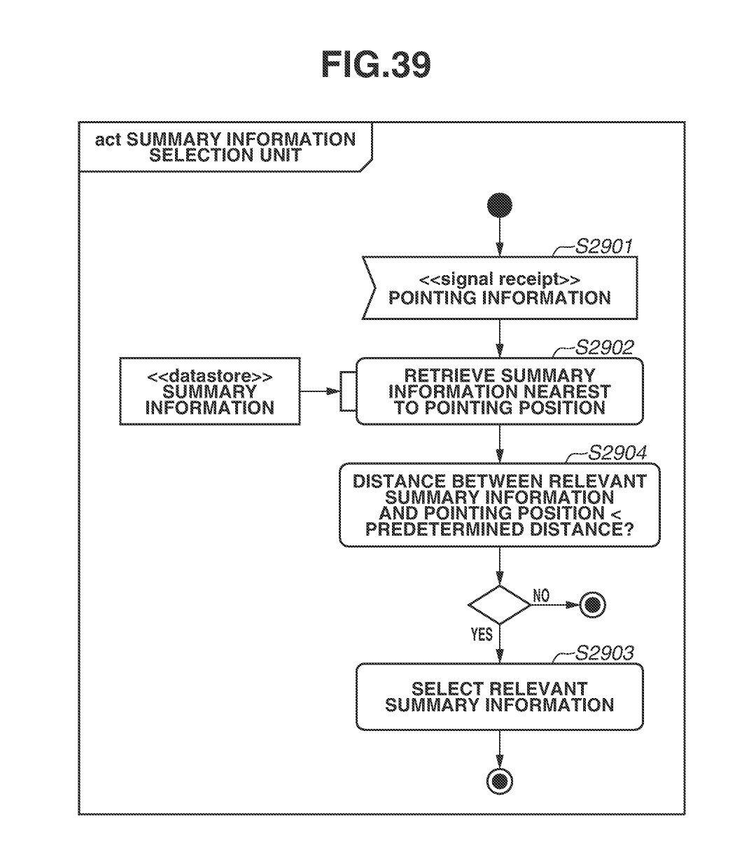

FIG. 39 illustrates an operation of the summary information selection unit 291 in this case. In FIG. 39, step S2904 is added to the processing in FIG. 37.

In step S2902, the summary information selection unit 291 retrieves the summary information nearest to the pointing position. Subsequently, in step S2904, the summary information selection unit 291 checks whether a distance between a position of the relevant summary information and the pointing position is less than a predetermined distance. When the distance is less than the predetermined distance (YES in step S2904), in step S2903, the summary information selection unit 291 selects the relevant summary information. Otherwise (NO in step S2904), the summary information selection unit 291 does not perform the selection operation.

As described above, the summary information at the position obviously distant from the pointing position is excluded from the selection target, and accordingly the summary information selection unit 291 can avoid selecting the wrong summary information when mistakenly reselecting the summary information.

For example, a part or whole of the functional configuration of the above-described information processing system 1 may be mounted on the summary information display device 2 or the detailed information display device 3 as hardware.

Each of the above-described exemplary embodiments may be arbitrarily combined.

According to the present invention, convenience can be improved.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-077659, filed Apr. 10, 2017, which is hereby incorporated by reference herein in its entirety.

What is claimed is:

1. A system comprising:
a generation unit configured to generate presentation information to a user based on a visual recognition target of the user;
a first display control unit configured to display the presentation information generated by the generation unit on a first display unit of a first information processing device;
a determination unit configured to determine detailed information related to the presentation information based on the presentation information displayed on the first display unit by the first display control unit;
a second display control unit configured to display the detailed information determined by the determination unit on a second display unit of a second information processing device which is different from the first information processing device;
a selection unit configured to select the presentation information corresponding to a designation from the user as selection information from among a plurality of the presentation information pieces displayed on the first display unit by the first display control unit; and
a first detection unit configured to perform detection processing for detecting that selection of the selection information by the selection unit is a selection mistake by the selection unit.

2. The system according to claim 1, wherein the selection unit performs control so that the selection information detected as the selection mistake by the selection unit by the first detection unit cannot be selected again.

3. The system according to claim 1, wherein, in a case where the selection information is detected as the selection mistake by the selection unit by the first detection unit, the selection unit selects again presentation information to be the selection information from among a plurality of the presentation information pieces displayed on the first display unit and excluding the selection information.

4. The system according to claim 1,
wherein the selection unit is a pointing device and selects presentation information nearest to a selected position as selection information, and
wherein the first detection unit detects as a selection mistake by the selection unit in a case where a distance between a position selected by the selection unit and a position selected by the selection unit immediately before is less than a predetermined value.

5. The system according to claim 4, wherein the selection unit does not perform selection in a case where a distance between a selected position and a position of the presentation information nearest to the selected position is greater than a predetermined value.

6. The system according to claim 1, further comprising:
a second detection unit configured to perform detection processing for detecting a gazing motion by the user at the detailed information displayed on the second display unit by the second display control unit, and
wherein the first detection unit performs detection processing for detecting that selection of the selection information by the selection unit is a selection mistake by the selection unit based on a transition of a result of the detection processing by the second detection unit.

7. The system according to claim 1,
wherein the generation unit generates the presentation information based on an image displayed on the first display unit as the visual recognition target, and
wherein the first display control unit displays the presentation information generated by the generation unit on the first display unit so as to superimpose on the image.

8. The system according to claim 1,
wherein the generation unit generates the presentation information based on an actual landscape visually recognized by the user via the first display unit as the visual recognition target, and
wherein the first display control unit displays the presentation information generated by the generation unit on the first display unit so as to superimpose on the actual landscape.

9. The system according to claim 1, wherein the first information processing device further includes an analysis unit configured to output information related to a visual recognition target of a user, and the generation unit generates the presentation information based on the information.

10. The system according to claim 1, further comprising:
a detection unit configured to perform detection processing for detecting a gazing motion by the user at the detailed information displayed on the second display unit by the second display control unit, and
in a case where the gazing motion is detected by the detection unit, the first display control unit prohibits display of the presentation information on the first display unit.

11. The system according to claim 10, wherein the detection unit performs the detection processing for detecting the gazing motion based on an orientation of the first information processing device.

12. The system according to claim 11, wherein the detection unit performs the detection processing for detecting the gazing motion based on an orientation of the second information processing device.

13. The system according to claim 11, wherein the detection unit performs the detection processing for detecting the gazing motion based on whether an image captured by an image capturing unit of the first information processing device includes the second display unit.

14. The system according to claim 11, wherein the detection unit performs the detection processing for detecting the gazing motion based on whether an image captured by an image capturing unit of the first information processing device includes the detailed information displayed on the second display unit.

15. The system according to claim 11, wherein the detection unit performs the detection processing for detecting the gazing motion based on whether an image captured by an image capturing unit of the second information processing device includes the first information processing device.

16. The system according to claim 11, wherein the detection unit performs the detection processing for detecting the gazing motion based on whether an image captured by an image capturing unit of the second information processing device includes the user.

17. The system according to claim 11, wherein the detection unit performs the detection processing for detecting the gazing motion based on whether an operation is being performed on the detailed information displayed on the second display unit by the second display control unit.

18. The system according to claim 1, wherein the first information processing device is a head-mounted type terminal device.

19. A method for processing information executed by a system, the method comprising:
generating presentation information to a user based on a visual recognition target of the user;
performing first display control for displaying the generated presentation information on a first display unit of a first information processing device;
determining detailed information related to the presentation information based on the presentation information displayed on the first display unit in the first display control;
performing second display control for displaying the determined detailed information on a second display unit of a second information processing device which is different from the first information processing device;
selecting the presentation information corresponding to a designation from the user as selection information from among a plurality of the presentation information pieces displayed on the first display unit in the first display control; and
performing detection processing for detecting that selection of the selection information in the selecting is a selection mistake by the selecting.

20. A nonvolatile storage medium storing a program for causing a computer to execute each process in a method for processing information, the method comprising:
generating presentation information to a user based on a visual recognition target of the user;
performing first display control for displaying the generated presentation information on a first display unit of a first information processing device;
determining detailed information related to the presentation information based on the presentation information displayed on the first display unit in the first display control;
performing second display control for displaying the determined detailed information on a second display unit of a second information processing device which is different from the first information processing device;
selecting the presentation information corresponding to a designation from the user as selection information from among a plurality of the presentation information pieces displayed on the first display unit in the first display control; and
performing detection processing for detecting that selection of the selection information in the selecting is a selection mistake by the selecting.
